(19) United States
(12) Patent Application Publication
(10) Pub. No.: US 2024/0273424 A1
(43) Pub. Date: Aug. 15, 2024

(54) MOBILE WORK REPORTING SYSTEMS AND METHODS

(71) Applicant: BNSF Railway Company, Fort Worth, TX (US)

(72) Inventors: Adam Bartek, Fort Worth, TX (US); Michael Moore, Saginaw, TX (US); Adam W. Rose, De Leon, TX (US); Andrew Shearer, Haslet, TX (US); Daniel Kleman, Haslet, TX (US); Anthony Bushong, Fort Worth, TX (US); Jerin Mathew, Oshawa (CA); Sheeyam Shellvacumar, Fort Worth, TX (US); Soni Saji, Mississauga (CA)

(73) Assignee: BNSF Railway Company, Fort Worth, TX (US)

(21) Appl. No.: 18/167,656

(22) Filed: Feb. 10, 2023

(51) Int. Cl. G06Q 10/0631; H04W 4/029

(52) U.S. Cl. CPC G06Q 10/0631; H04W 4/029

(57) ABSTRACT

A system and methods for mobile reporting of railroad operations. The system can estimate a current geographic location of railway assets, defects, and projects based on input from at least a global positioning system (GPS) receiver and a graphical user interface (GUI). The system can display a geographic region of interest and estimate a location of a client device of the user based on geo-coded information. In this way, a network of users can determine a location of the railway assets, defects, and project locations and corresponding updates in real-time.

### TECHNICAL FIELD

The present disclosure relates generally to geopositioning of client devices with respect to managing mobile work reporting (MWR) of railway assets, defects, and project locations, particularly a system and methods for mobile reporting of railroad operations.

### BACKGROUND

Geolocating railway assets, defects, and project locations can lead to significant delays in resolving issues for a railroad system. Considering approximately 30% of the railway network in the United States cannot receive sufficient wireless coverage by communication networks, geolocating without established communication networks can be critical for organizations. For example, signal technicians may need to identify why a railway signal in a remote area changed unexpectedly causing any railway traffic to stop. Because of the lack of established communication networks along the railway, identifying the correct signal can require a railway gang to identify a known signal proximate to the broken signal and use dead-reckoning to estimate a distance and location of the broken signal. The inability to geolocate railway assets, defects, and project locations can cause operational strain and hazardous environments.

The current methods cannot identify locations of the railway assets, defects, and project locations. The archaic dead-reckoning technique requires the network of users to predict a location of where the work will be complete without any degree of precision. The current method fails to go beyond mere visual inspection of a location and desperately is in need of an upgrade for handling the information exchange. In situations without efficient information exchanges, important aspects to managing railway assets, defects, and project locations can be missed resulting in inefficiencies on the rail system, significant delays in railway traffic, and hazardous environments along the rail way. The goal for managing railway assets, defects, and project locations is to identify the root cause of the service interruption and remedy any issues along the railway in a predictable time such that rail way traffic can resume without constraints. Currently, railway gangs must estimate a location of the railway assets, defects, and project locations and continually monitor thousands of emails for updated information, which is often-times incomplete because records in separate locations are untimely or locally stored or cannot be viewed due to insufficient wireless network coverage.

### SUMMARY

The present disclosure provides for a system integrated into a practical application with meaningful limitations as a system and methods for mobile reporting of railroad operations. The system can estimate a current geographic location of railway assets, defects, and projects based on input from at least a global positioning system (GPS) receiver and a graphical user interface (GUI). The system can display a geographic region of interest and estimate a location of a client device of the user based on geo-coded information. In this way, a network of users can determine a location of the railway assets, defects, and project locations. The system can provide the users various options to provide a social platform for the responders to communicate. For example, the GUI connecting the network of responders can provide a status update for relevant responders to communicate in real-time to efficiently remedy the railway assets, defects, and project locations.

Accordingly, the present disclosure discloses concepts inextricably tied to computer technology such that the present disclosure provides the technological benefit of calculating the geographic location of the client device, railway assets, defects, and project locations based on geo-coded information to generate an update for the network of users in real-time. A client device including a GPS receiver receives input from the user to further refine the location of the user and the scheduled work along the segment of track enabling the network of users to track the location to avoid hazardous environment for the field users. The system can improve GPS techniques by enabling the GPS receiver to determine its position more accurately and improve its signal-acquisition sensitivity to operate even in weak-signal environments with input from proximate network connections (i.e., networks initiated by the user). In particular, the client device can include a mobile device that includes a GPS receiver, a microprocessor, a display, and a wireless communication transceiver.

The present disclosure can provide a GUI by a content server interfacing an entire network of responders while minimizing clutter and distractions from ineffective communications. The present disclosure can provide a GUI by a content server, which is hardware or a combination of both hardware and software. A user, such as a member of a rail gang, is given remote access through the GUI to view or update information about at least one of the railway assets, defects, and projects using the user's own local device (e.g., a mobile device or personal computer). When a user wants to update a status of at least one of the railway assets, defects, and projects, the user can input the update from the user's local device. Whenever the information is updated, it can be stored in a collection of railway information on one or more of the network-based storage devices. After the updated information about the railway assets, defects, and projects has been stored in the network, the content server, which is connected to the network-based storage devices, immediately generates a message containing the updated information. This message is transmitted over a computer network to all users that have access to the railway information such that all users can quickly be notified of any changes without having to manually look up or consolidate all the updates. The present disclosure can ensure each of a group of users is always given immediate notice and access to changes so they can readily adapt maintenance strategies in accordance with other responder actions. The message can be in the form of an email message, text message, or other type of message known in the art.

The present disclosure provides a technological solution missing from conventional systems by at least providing a method for geolocating client devices and locations of railway assets, defects, and project locations to enable managing railway operations in real-time across a network of users. The present disclosure surpasses the conventional approaches by providing precision geolocation for resolving issues along the railway. The present disclosure avoids adding strain on an already overspent system by providing at least the following functionality:
Geolocating a client device to cross-reference proximate locations of at least one of the railway assets, defects, and projects for managing and reporting work along a segment of track;
Providing refined locations for accurate management of the railway assets, defects, and projects along the segment of track;
Providing real-time communications across an entire organization while minimizing communication bottlenecks;
Providing a GUI for simplifying and managing communications for an MWR system; and
Optimizing communications by identifying relevant information based on technical groups corresponding to the railway assets, defects, and projects.

It is an object of the invention to provide a method for mobile reporting of railroad operations. It is a further object of the invention to provide a system for mobile reporting of railroad operations. It is a further object of the invention to provide a computer-implemented method for mobile reporting of railroad operations. These and other objects are provided by at least the following embodiments.

In one embodiment, a method for mobile reporting of railroad operations, including: determining a location, at a mobile device comprising a global positioning system (GPS) receiver, a microprocessor, a display, and a wireless communication transceiver, by displaying a course location received by the GPS receiver from a plurality of GPS satellites and receiving a location refinement from a user; refining the location using a user interface configured to display a map and a location icon on the mobile device; reporting temporary and permanent remedial actions, root causes, measurements, methods of repair, and photos and/or notes as applicable to various defect types; using a hub design that shows user work around the location; embedding training components relevant to a current task; geo-coding track safety information; and automatically reporting track inspection work orders. Wherein the method further comprising generating automated estimated time of arrival with turn-by-turn directions, asset specific or GPS pinpoint location accuracy, close out codes, and photo/notes. Wherein the method further comprising automatically reporting all track inspection work orders. Wherein the method further comprising generating a max ambient temperature forecasted based on a project location. Wherein the method further comprising estimating a rail neutral temperature (RNT) based on a change in rail length, length of unrestrained rail, a coefficient of expansion, and a track neutral temperature (TNT). Wherein the method further comprising locally storing a project file in a structured format and wirelessly transmitting the project file to a gang client device. Wherein the method further comprising displaying a first distance range and a second distance range along the segment of track. Wherein the method further comprising measuring the first distance range and the second distance range based on a railway centerline from positive train control (PTC) data. Wherein the method further comprising generating a project corresponding to a rail, a ballast, or at least one railway tie. Wherein the method further comprising generating the project corresponding to the rail to compensate for railway asset repair including digitally assigning user information to the railway asset repair.

In another embodiment, a system for mobile reporting of railroad operations, including: a mobile device comprising: a GPS receiver; a microprocessor, wherein the microprocessor is configured to receive instructions corresponding to the operations of the mobile device; a wireless communication transceiver; and a display; a memory for storing information about railway assets, defects, and projects in a plurality of network-based non-transitory storage devices having the collection of railway information thereon; and a networked computer processor operably coupled to the memory and capable of executing machine-readable instructions to perform program steps, the program steps comprising: determining a location, at a mobile device comprising a GPS receiver, a microprocessor, a display, and a wireless communication transceiver, by displaying a course location received by the GPS receiver from a plurality of GPS satellites and receiving a location refinement from a user; refining the location using a user interface configured to display a map and a location icon on the mobile device; reporting temporary and permanent remedial actions, root causes, measurements, methods of repair, and photos and/or notes as applicable to various defect types; using a hub design that shows user work around the location; embedding training components relevant to a current task; geo-coding track safety information; and automatically reporting track inspection work orders. Wherein the program steps further cause the processor to perform the step of generating automated estimated time of arrival with turn-by-turn directions, asset specific or GPS pinpoint location accuracy, close out codes, and photo/notes. Wherein the program steps further cause the processor to perform the step of automatically reporting all track inspection work orders. Wherein the program steps further cause the processor to perform the step of generating a max ambient temperature forecasted based on a project location. Wherein the program steps further cause the processor to perform the step of estimating a RNT based on a change in rail length, length of unrestrained rail, a coefficient of expansion, and a TNT. Wherein the program steps further cause the processor to perform the step of locally storing a project file in a structured format and wirelessly transmitting the project file to a gang client device. Wherein the program steps further cause the processor to perform the step of displaying a first distance range and a second distance range along the segment of track. Wherein the program steps further cause the processor to perform the step of measuring the first distance range and the second distance range based on a railway centerline from positive train control (PTC) data. Wherein the program steps further cause the processor to perform the step of generating a project corresponding to a rail, a ballast, or at least one railway tie. Wherein the program steps further cause the processor to perform the step of generating the project corresponding to the rail to compensate for railway asset repair including digitally assigning user information to the railway asset repair.

In another embodiment, a computer-implemented method for mobile reporting of railroad operations, including: determining a location, at a mobile device comprising a GPS receiver, a microprocessor, a display, and a wireless communication transceiver, by displaying a course location received by the GPS receiver from a plurality of GPS satellites and receiving a location refinement from a user; refining the location using a user interface configured to display a map and a location icon on the mobile device; reporting temporary and permanent remedial actions, root causes, measurements, methods of repair, and photos and/or notes as applicable to various defect types; using a hub design that shows user work around the location; embedding training components relevant to a current task; geo-coding track safety information; and automatically reporting track inspection work orders. Wherein the computer-implemented method further comprising generating automated estimated time of arrival with turn-by-turn directions, asset specific or GPS pinpoint location accuracy, close out codes, and photo/notes. Wherein the computer-implemented method further comprising automatically reporting all track inspection work orders. Wherein the computer-implemented method further comprising generating a max ambient temperature forecasted based on a project location. Wherein the computer-implemented method further comprising estimating a RNT based on a change in rail length, length of unrestrained rail, a coefficient of expansion, and a TNT. Wherein the computer-implemented method further comprising locally storing a project file in a structured format and wirelessly transmitting the project file to a gang client device. Wherein the computer-implemented method further comprising displaying a first distance range and a second distance range along the segment of track. Wherein the computer-implemented method further comprising measuring the first distance range and the second distance range based on a railway centerline from PTC data. Wherein the computer-implemented method further comprising generating a project corresponding to a rail, a ballast, or at least one railway tie. Wherein the computer-implemented method further comprising generating the project corresponding to the rail to compensate for railway asset repair including digitally assigning user information to the railway asset repair.

### BRIEF DESCRIPTION OF THE DRAWINGS

The present disclosure will be readily understood by the following detailed description, taken in conjunction with the accompanying drawings that illustrate, by way of example, the principles of the present disclosure. The drawings illustrate the design and utility of one or more exemplary embodiments of the present disclosure, in which like elements are referred to by like reference numbers or symbols. The objects and elements in the drawings are not necessarily drawn to scale, proportion, or precise positional relationship. Instead, emphasis is focused on illustrating the principles of the present disclosure.

FIG. 1 illustrates a schematic view of an MWR system, in accordance with one or more exemplary embodiments of the present disclosure;

FIG. 2 illustrates an MWR system, in accordance with one or more exemplary embodiments of the present disclosure;

FIG. 3 illustrates a block diagram of an MWR system, in accordance with one or more exemplary embodiments of the present disclosure;

FIGS. 4A-4C illustrate a flowchart exemplifying MWR control logic, in accordance with one or more exemplary embodiments of the present disclosure;

FIGS. 5A-5D illustrate an MWR assets interface, in accordance with one or more exemplary embodiments of the present disclosure;

FIGS. 6A-6G illustrate an MWR defects interface, in accordance with one or more exemplary embodiments of the present disclosure;

FIGS. 7A-7H illustrate an MWR projects interface, in accordance with one or more exemplary embodiments of the present disclosure;

FIGS. 8A-8K illustrate an MWR range interface, in accordance with one or more exemplary embodiments of the present disclosure;

FIGS. 9A-9L illustrate an MWR projects interface, in accordance with one or more exemplary embodiments of the present disclosure;

FIG. 10 illustrates a flowchart exemplifying MWR control logic, in accordance with one or more exemplary embodiments of the present disclosure;

FIG. 11 illustrates a flowchart exemplifying MWR control logic, in accordance with one or more exemplary embodiments of the present disclosure;

FIG. 12 illustrates a flowchart exemplifying MWR control logic, in accordance with one or more exemplary embodiments of the present disclosure;

FIG. 13 illustrates a flowchart exemplifying MWR control logic, in accordance with one or more exemplary embodiments of the present disclosure;

FIG. 14 illustrates a flowchart exemplifying MWR control logic, in accordance with one or more exemplary embodiments of the present disclosure;

FIG. 15 illustrates a flowchart exemplifying MWR control logic, in accordance with one or more exemplary embodiments of the present disclosure;

FIG. 16 illustrates a flowchart exemplifying MWR control logic, in accordance with one or more exemplary embodiments of the present disclosure; and

FIG. 17 illustrates a flowchart exemplifying MWR control logic, in accordance with one or more exemplary embodiments of the present disclosure.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. A patent examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

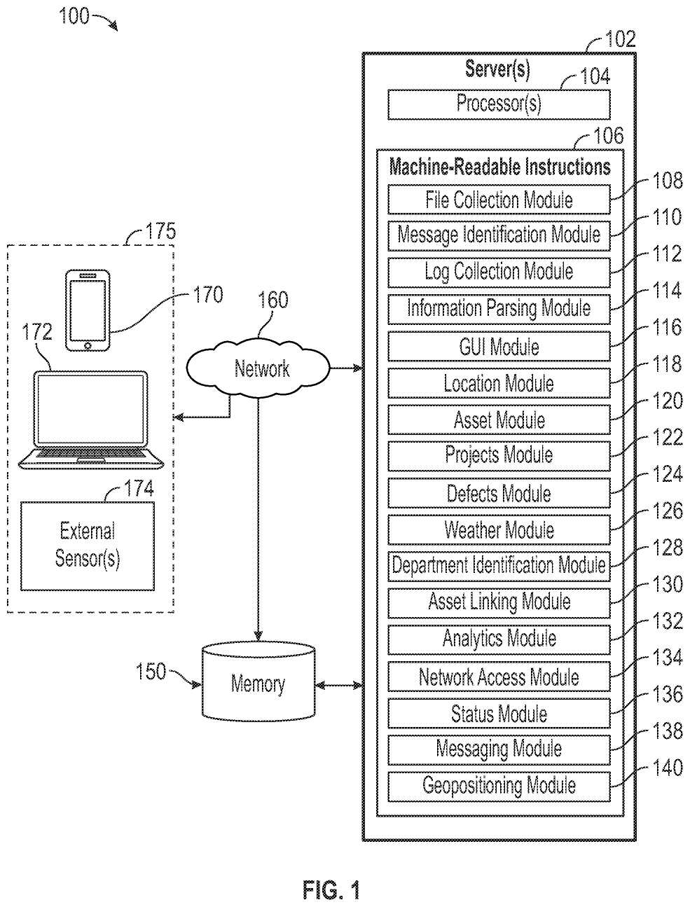

FIG. 1 illustrates a schematic view of an MWR system 100, in accordance with one or more embodiments of the present disclosure. The system 100 can include one or more server(s) 102 having one or more processor(s) 104, a memory 150, machine readable instructions 106, including a file collection module 108, message identification module 110, log collection module 112, information parsing module 114, GUI module 116, location module 118, asset module 120, projects module 122, defects module 124, weather module 126, department identification module 128, asset linking module 130, Analytics module 132, network access module 134, Status module 136, messaging module 138, geopositioning module 140, among other relevant modules. The server(s) 102 can be operably coupled to one or more clients via a network 160. The clients can be a physical device (e.g., a client device 175 including a mobile phone 170, laptop 172, external sensors 174, desktop computer, wearable device, or other suitable device), program, or application. In another embodiment, the client device 175 can include a mobile phone 170 having a mobile application configured to communicate with the server(s) 102 over the network 160.

The aforementioned system components (e.g., server(s) 102 and client device 175 including 170, 172, 174, etc.) can be communicably coupled to each other via the network 160, such that data can be transmitted. The network 160 can be the Internet, intranet, or other suitable network. The data transmission can be encrypted, unencrypted, over a virtual private network (VPN) tunnel, or other suitable communication means. The network 160 can be a wide area network (WAN), local area network (LAN), personal area network (PAN), or other suitable network type. The network communication between the clients, server(s) 102, or any other system component can be encrypted using pretty good privacy (PGP), Blowfish, Twofish, triple data encryption standard (3DES), hypertext transfer protocol secure (HTTPS), or other suitable encryption. The system 100 can be configured to provide communication via the various systems, components, and modules disclosed herein via an application programming interface (API), peripheral component interface (PCI), PCI-Express, American National Standards Institute (ANSI)-X12, Ethernet, Wi-Fi, Bluetooth, or other suitable communication protocol or medium. Additionally, third party systems and databases can be operably coupled to the system components via the network 160.

The data transmitted to and from the components of system 100 (e.g., the server(s) 102 and clients), can include any format, including JavaScript Object Notation (JSON), transfer control protocol (TCP)/internet protocol (IP), extensible markup language (XML), hypertext markup language (HTML), American Standard Code for Information Interchange (ASCII), short message service (SMS), comma-separated value (CSV), representational state transfer (REST), or other suitable format. The data transmission can include a message, flag, header, header properties, metadata, and/or a body, or be encapsulated and packetized by any suitable format having same.

The server(s) 102 can be implemented in hardware, software, or a suitable combination of hardware and software therefor, and may comprise one or more software systems operating on one or more servers, having one or more processor(s) 104, with access to memory 150. Server(s) 102 can include electronic storage, one or more processors, and/or other components. Server(s) 102 can include communication lines, connections, and/or ports to enable the exchange of information via a network 160 and/or other computing platforms. Server(s) 102 can also include a plurality of hardware, software, and/or firmware components operating together to provide the functionality attributed herein to server(s) 102. For example, server(s) 102 can be implemented by a cloud of computing platforms operating together as server(s) 102, including Software-as-a-Service (SaaS), Platform-as-a-Service (PaaS), Infrastructure-as-a-Service (IaaS) functionality. Additionally, the server(s) 102 can include memory 150.

Memory 150 can comprise electronic storage that can include non-transitory storage media that electronically stores information. The electronic storage media of electronic storage can include one or both of system storage that can be provided integrally (e.g., substantially non-removable) with server(s) 102 and/or removable storage that can be removably connectable to server(s) 102 via, for example, a port (e.g., a Universal Serial Bus (USB) port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., erasable electronic programmable read only memory (EEPROM), random access memory (RAM), etc.), solid-state storage media (e.g., flash drive, etc.), and/or other electronically readable storage media. Electronic storage may include one or more virtual storage resources (e.g., cloud storage, a virtual private network, and/or other virtual storage resources). The electronic storage can include a database, or public or private distributed ledger (e.g., blockchain). Electronic storage can store machine-readable instructions 106, software algorithms, control logic, data generated by processor(s), data received from server(s), data received from computing platform(s), and/or other data that can enable server(s) to function as described herein. The electronic storage can also include third-party databases accessible via the network 160.

Processor(s) 104 can be configured to provide data processing capabilities in server(s) 102. As such, processor(s) 104 can include one or more of a digital processor, an analog processor, a digital circuit designed to process information, an analog circuit designed to process information, a state machine, and/or other mechanisms for electronically processing information, such as field programmable gate arrays (FPGAs) or application specific integrated circuits (ASICs). The processor(s) 104 can be a single entity or include a plurality of processing units. These processing units can be physically located within the same device, or processor(s) 104 can represent processing functionality of a plurality of devices or software functionality operating alone, or in concert.

The processor(s) 104 can be configured to execute machine-readable instructions 106 or machine learning modules via software, hardware, firmware, some combination of software, hardware, and/or firmware, and/or other mechanisms for configuring processing capabilities on processor(s) 104. As used herein, the term “machine-readable instructions” can refer to any component or set of components that perform the functionality attributed to the machine-readable instructions 106 component. This can include one or more physical processor(s) 104 during execution of processor-readable instructions, the processor-readable instructions, circuitry, hardware, storage media, or any other components.

The server(s) 102 can be configured with machine-readable instructions having one or more functional modules. The machine-readable instructions 106 can be implemented on one or more servers 102, having one or more processor(s) 104, with access to memory 150. The machine-readable instructions 106 can be a single networked node, or a machine cluster, which can include a distributed architecture of a plurality of networked nodes. The machine-readable instructions 106 can include control logic for implementing various functionality, as described in more detail below. The machine-readable instructions 106 can include certain functionality associated with the system 100. Additionally, the machine-readable instructions 106 can include a smart contract or multi-signature contract that can process, read, and write data to the database, distributed ledger, or blockchain.

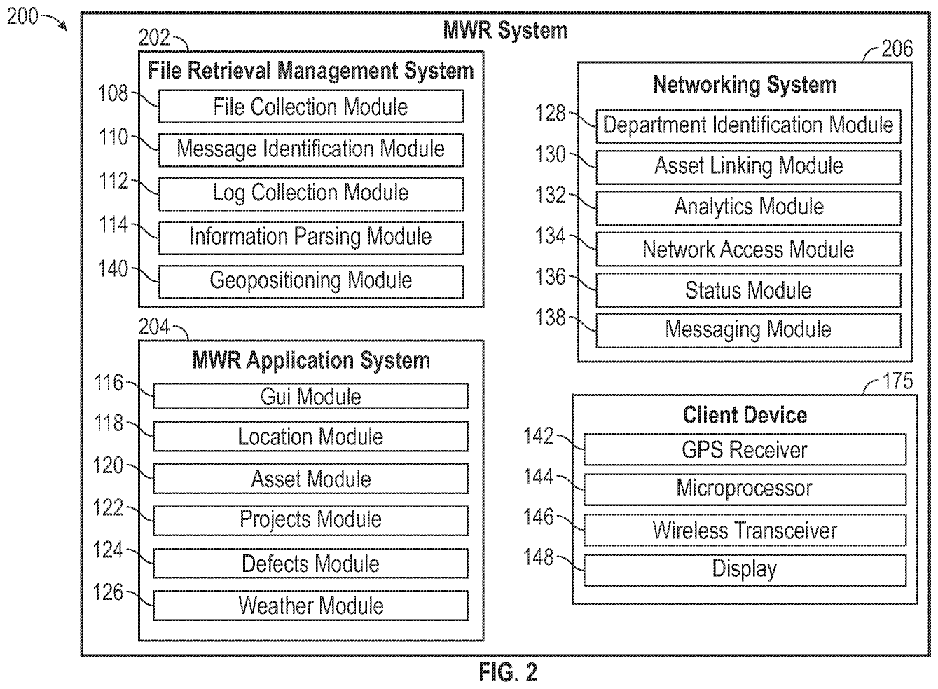

FIG. 2 illustrates a schematic view of an MWR system 200, in accordance with one or more embodiments of the present disclosure. The MWR system 200 can include a file retrieval management system 202, an MWR application system 204, a networking system 206, and the client device 175. Although certain embodiments may be directed to responding to railway occurrences, the MWR system 200 can be used to respond to events across various industries, such as roadway transportation, air traffic control, construction management, or another such industry with a need to efficiently communicate across an organization.

In one embodiment, the file retrieval management system 202 can include the file collection module 108, the message identification module 110, the log collection module 112, the information parsing module 114, and the geopositioning module 140. The file collection module 108, the file parsing module 110, the log collection module 112, and the information parsing module 114 can implement one or more algorithms to facilitate retrieval of files and logs of railroad events for various systems, including status, selection, and authentication algorithms. The algorithms can be programmable to suit particular railroad events, application, function, facility, or other requirement. The file retrieval management system 202 can be configured to retrieve and modify files and logs related to at least one of railway assets, defects, and projects, or other suitable activity, to and from the client or server. In another embodiment, the file retrieval management system 202 can generate one or more elements for display on the user device. The elements can provide additional information related to the status of the railway assets, defects, and projects. For example, notifications can be generated by the file retrieval management system 202 and displayed on the client to indicate file collections, log parsing, automated workflow initialization, railroad event handling, errors, or other suitable information. Additionally, system symbols can be displayed on the client to indicate task, inspection, or analysis status.

The file collection module 108, in an embodiment, can store information about the railway assets, defects, and projects in a plurality of network-based non-transitory storage devices having a collection of railway information thereon. For example, the railroad event notification can include notices regarding the railway assets, defects, and projects, such as a geographic marker indicating a location of a defect in a railway asset along a railroad track. In one embodiment, the file collection module 108 can receive the incoming messages from a network-operated server. For example, the incoming messages can correspond to one or more of the railway assets, defects, and projects. In another embodiment, the file collection module 108 can transmit outgoing messages to the network-operated server. For example, the outgoing messages can request system component logs corresponding to one or more of the railway assets, defects, and projects.

In another example, the file collection module 108 can generate an authentication token for a particular user, session, or request. In another embodiment, the file collection module 108 can access the network 160 without user credentials. In another embodiment, the file collection module 108 can generate an authentication token using user data stored in the client. For example, a user can access a client and/or the system 200 by providing valid credentials via a login page or screen, including a username and password, biometrics, multi-factor authentication, or other suitable credential, such credentials, along with a user's information such as name, username, employee number, etc., can be stored in the client or server. In another embodiment, the file collection module 108 can process at least a portion of the credentials and/or user information to generate an authentication token. For example, the authentication token can be generated as a JSON Web Token (JWT), via dongles or key fobs that can periodically generate a new authentication token in accordance with a known algorithm, using an authenticator app on the client or sent on demand via SMS, by hashing at least a portion of the login credentials, or other suitable methodology.

In another example, the authentication token can allow for single sign-on authentication to the server and/or memory from the client. In another embodiment, the file collection module 108 can operate without a user interface. In another example, the file collection module 108 can provide a user interface for a user to access the file collection module 108. The system 200 can utilize the file collection module 108 to provide a user interface for receiving relevant data.

The message identification module 110, in an embodiment, can classify the incoming messages and the notification. In one embodiment, the message identification module 110 can receive information about at least one of the railway assets, defects, and projects from the incoming messages and the notification. For example, the message identification module 110 can classify the incoming messages as an update to the project or a status request and classify the notification as a log status. In another embodiment, the message identification module 110 can identify the system component logs corresponding to the railway assets, defects, and projects. For example, the message identification module 110 can identify the characteristics of the railway assets, defects, and projects to organize the messages according to a particular category. In another example, the characteristics can include a location, a primary technical group responsible for the railway assets, defects, and projects, a location of a user, asset type associated, network information, software version, operating system version, among other relevant characteristics.

The log collection module 112, in an embodiment, can receive the system component logs. In one embodiment, the system component logs are sent from the network-operated server. In another embodiment, the log collection module 112 can download the system component logs from an external memory. The system component logs can correspond to default set of onboard logs from at least one CPU on board the train. The system component logs can indicate characteristics of the enforcement of the brake event. In another embodiment, the log collection module 112 can store the system component logs for future access.

The information parsing module 114, in an embodiment, can parse the incoming messages and the notification for relevant information. For example, the information parsing module 114 can filter a list of search results corresponding to user-inputted text corresponding to at least one of the railway assets, defects, and projects. In an example, the relevant information can include information regarding details of at least one of the railway assets, defects, and projects. In another example, the incoming messages can include information such as a user ID, the employee information on the train, the employee requesting the information, a location of the railway assets, defects, and projects, among other relevant information. In one embodiment, the information parsing module 114 can establish a connection to a database. For example, the information parsing module 114 can receive the incoming message from the database and transmit the relevant information to the database.

The geopositioning module 140, in an embodiment, can receive a location of the client from the client. In another exemplary embodiment, the client can include a GPS radio to receive GPS signals and determine the location of the client from the received GPS signals. In another exemplary embodiment, the client can triangulate its location using two or more received signals via a radio operably coupled or embedded within the mobile device. In another exemplary embodiment, the client can determine its location using a Wi-Fi positioning system that can uses the characteristics of nearby Wi-Fi hotspots and other wireless access points to discover where the client is located. The client location can be transmitted to the geopositioning module 140 via an encrypted network. For example, during a rail inspection, a user can begin inspecting a rail segment by beginning at a start point on a first end of the rail segment and capture a series of data points related to the segment. In order to begin logging the data related to an inspection, the user's location must first be determined. In one exemplary embodiment, the user's location can be identified by receiving one or more characteristics of the user's location (e.g., line segment, milepost location, etc.) or by utilizing the GPS functionality of the client. In another exemplary embodiment, once the GPS location (latitude and longitude coordinates) are determined, the geopositioning module 140 can determine one or more characteristics of the user's location (e.g., line segment, milepost location, curve—high rail or low rail, etc.). In another exemplary embodiment, the GPS coordinates can determine the line segment and the mileposts by correlating the GPS coordinates with those stored in a geographic information system (GIS) database. For example, a GIS database can include one or more rail segment characteristics associated with a particular latitude and longitude coordinate.

The MWR application system 204, in an embodiment, can include the GUI module 116, location module 118, Asset module 120, projects module 122, defects module 124, and Weather module 126. The GUI module 116, location module 118, asset module 120, projects module 122, defects module 124, and weather module 126 can implement one or more algorithms to facilitate status monitoring of at least one of the railway assets, defects, and projects. For example, the algorithms can correspond to GUI display, interacting with the user, and updating information corresponding to the interaction with the user. The algorithms can be programmable to suit a particular railway asset, defect, and project, application, function, facility, or other requirement. The MWR application system 204 can be configured to transmit and receive messages related to status monitoring or other suitable activity, to and from the client or server. In another embodiment, the MWR application system 204 can generate one or more elements for display on the client. The elements can provide additional information related to workflow automation. For example, a notification can be generated by the MWR application system 204 and displayed on the client to indicate a status update, system component log status, start of an automation service, or other suitable information. Additionally, system symbols can be displayed on the client to indicate management status.

The GUI module 116, in an embodiment, can provide a display to interact with a project file and interface a user with a network or users. For example, the GUI module 116 can display a GPS-based interface for a particular geographic region including a location of the railway assets, defects, and projects. In an example, the GUI module 116 can include various reference points indicating an open or closed icon for a particular location. The various reference points can include a changeable icon depending on a status of the railway assets, defects, and projects. For example, the icon can include a first icon when the railway assets, defects, and projects are open and a second icon when the railway assets, defects, and projects are closed. In an example, the first icon can include a red circle indicating the railway assets, defects, and projects are open. In another example, the second icon can include a green circle indicating the railway assets, defects, and projects are closed. In an example, the GUI module 116 can display the GPS-based interface spanning the entire country or can display a local geographic region to the user. The GUI module 116 can interact with the user allowing the user to search through various labels for an overview of all the open railway assets, defects, and projects search results.

In another example, the GUI module 116 can receive an input selecting one of the search results to display additional information. For example, the GUI module 116 can interact with a display of a client device 175 (e.g., 170, 172, 174 from FIG. 1) to receive the input. In an example, the user can interact with the GUI module 116 using a touch screen interface of the client device 175. The additional information displayed by the GUI module 116 can include information related to at least one of the railway assets, defects, and projects corresponding to the search result the user selected. For example, the additional information can include an assessed cause of the defects, a root cause of the defects, a classification of the railway assets, defects, and projects to a particular department in an organization, a location of the railway assets, defects, and projects, a status of the railway assets, defects, and projects, among other relevant information. For example, the assessed cause of the defects can be an initial cause of the defects prior to gathering any further information. In an example, prior to a technician investigating the defects, the initial report can include incorrect information about the cause of the defects. In response to the incorrect information, the technician can input information to the GUI module 116 to update the status to a new cause of the defects. In an example, the new cause can correspond to the root cause. The department in the organization can include a technical team corresponding to at least one of the railway assets, defects, and projects. For example, when the cause of the defects are known to be a track malfunction, the track technical team can be notified to respond to the defects. The location of the railway assets, defects, and projects can include a line segment of a railway track, a milepost marker of the railway track, and a track designation (e.g., main track, side track, hand throw switch, etc.).

The location module 118, in an embodiment, can edit the location of the railway assets, defects, and projects when the type of interaction includes an edit location response. In an example, the location module 118 can convert the interaction on the interface to a string of binary values segmented in various bit length sections. For example, each of the sections can include a particular number of bits corresponding to the type of interaction. For example, the interface for the user to respond to the railway assets, defects, and projects can include an indicator prompting the user to edit the location. The indicator can correspond to a plurality of bits. In an example, when the user interacts with the indicator to edit the location, the bit value corresponding to the indicator can be at least one binary value. In another example, the location module 118 can incorporate a geographic location-based interface for the user to identify a new location for the railway assets, defects, and projects. For example, the geographic location-based interface can include a map of the region surrounding the user for the user to identify the new location. In an example, the user can identify the new location by entering a location manually or for the location module 118 to identify a location based on information from the client device 175 with which the user is interacting. For example, the client device 175 can transmit location-based information corresponding to the location of the client device 175 to the location module 118. The location module 118 can identify the location and store the location of the client device 175 locally or in an external data storage device (e.g., the memory 150).

The asset module 120, in an embodiment, can reference at least one railway asset when the type of interaction includes an asset and close out response. In an example, the asset module 122 can convert the interaction on the interface to a string of binary values segmented in various bit length sections. For example, each of the sections can include a particular number of bits corresponding to the type of interaction. For example, the interface for the user to input asset information and close out information can include an indicator prompting the user to include information about a user technical department, an asset type or association, and a close out code. The indicator can correspond to a plurality of bits. In an example, when the user interacts with the indicator to include the asset information or the close out information, the bit value corresponding to the indicator can be at least one binary value.

In another example, the asset module 120 can include an interactive field corresponding to the responder department. For example, the responder department can include a particular technical group corresponding to the asset. In an example, the responder department can include a track department, a transportation department, a mechanical department, a road department, a signal department, and a structure department. In another example, asset module 122 can include an interactive field corresponding to the asset type or association. For example, the asset type can correspond with a railway asset along a segment of track. In an example, the asset type can include a turnout, a road crossing, a bridge, a culvert, a detector, a wind fence, a signal enclosure, or a wayside signal. In another example, the asset module 122 can include an interactive field corresponding to the close out code. For example, the close out code can correspond with a particular issue corresponding to the asset. In an example, the close out code can include blown out weld, broken rail—impassable, broken rail—passable, gage—tight, gage—wide, geo car, joint—broken angle bar, joint—critical joint, joint—pull apart, rail detector—multiple defects, rail detector—single defect, rail detector—testing, slow order—inspection frequency, snow covered signal, surface—rough track, surface—subgrade, thermal misalignment, tie condition, tight rail concern, weather—no damage, weather—scour, weather—washout, collapsed, plugged, separated, falling rocks, minor repair needed, no cause found, slide event, insulated joint (IJ)—broken bars, IJ—failed insulation, IJ—rail shavings, IJ—slotted end post, high/damaged plank, vehicle/trailer strike with damage, vehicle/trailer strike without damage, frog—rail defect/failed, frog—welding wire in track, frog welding—planned work, frog welding—service interruption (SI) response, movable point frog—other, or another type of close out code not listed in the present disclosure.

The projects module 122, in an embodiment, can reference the user to a project. For example, the project modules 122 can identify the user based on a login identifier such that the projects module 122 can query a database of projects associated to a railway gang associated to the user. In this manner, the projects module 122 can compare the login identifier to the database information to identify corresponding projects associated to the user. The projects module 122 can display the associated projects to the user. In an example, the projects module 122 can display at least one project associated to the user. In another example, the projects module 122 can display no projects when the user is not associated to any projects. Alternatively, the projects module 122 can receive an input from the user to generate a new project. The new project can include prompts for the user to input information about the new project. The projects module 122 can identify the location of the user and prompt the user whether the new project is associated to any surrounding railway assets proximate to the location of the user. For example, the location of the user can correspond to a plurality of railway assets. In an example, the projects module 122 can prompt the user to determine whether the new project is associated to a proximate railroad tie for maintenance.

The defects module 124, in an embodiment, can include an interactive field corresponding to a railway department corresponding to the user. For example, the railway department can include a particular technical group responding to a project. In an example, the railway department can include a track department, a transportation department, a mechanical department, a road department, a signal department, and a structure department. In another example, the defects module 124 can include an interactive field corresponding to a defect type or association corresponding to the defect. For example, the defect type can correspond with a railway asset included as a cause of the project. In an example, the defect type can include a turnout, a road crossing, a bridge, a culvert, a detector, a wind fence, a signal enclosure, or a wayside signal. In another example, the defect module 124 can include an interactive field corresponding to the close out code. For example, the close out code can correspond with a particular cause of the project.

The weather module 126, in an embodiment, can retrieve weather data corresponding to a project location. For example, when the project location is known, the weather module 126 can query a weather database for corresponding weather information for the project location. In an example, the weather module 126 can display the weather data corresponding to the project location. In another example, the weather module 126 can aggregate the weather data to calculate a max ambient temperature forecasted based on the project location. The max ambient temperature forecasted can be an average of the weather data. For example, the weather module 126 can add the high temperatures for a forecast over a known project duration and divide the outcome by the known project duration to calculate the max ambient temperature forecasted.

In one embodiment, the networking system 206 can include the department identification module 128, asset linking module 130, analytics module 132, network access module 134, status module 136, and messaging module 138. The department identification module 128, asset linking module 130, analytics module 132, network access module 134, status module 136, and messaging module 138 can implement one or more algorithms to facilitate monitoring and updating a status of the railway assets, defects, and projects. For example, the algorithms can include identifier matching, metadata association, data analysis, among other algorithms relevant corresponding to the railway assets, defects, and projects. The algorithms and their associated thresholds and/or signatures can be programmable to suit a particular railroad event monitoring system, application, function, facility, or other requirement. The networking system 206 can be configured to transmit and receive messages related to the railway assets, defects, and projects or other suitable activity, to and from the client or server. In another embodiment, the networking system 206 can generate one or more elements for display on the user device. The elements can provide additional information related to the railway assets, defects, and projects. For example, a notification can be generated by the networking system 206 and displayed on the client to indicate a root cause is identified, system component logs extracted, event monitoring, or other suitable information. Additionally, system symbols can be displayed on the client to indicate an event status, analysis completion, or root cause of the railway assets, defects, and projects.

The department identification module 128, in an embodiment, can associate at least one of the railway assets, defects, and projects with a corresponding technical group. For example, the department identification module 128 can sort updates corresponding to the railway assets, defects, and projects based on an identifier of an associated technical group. In another example, the department identification module 128 can store any information corresponding to the railway assets, defects, and projects organized based on the technical groups.

The asset linking module 130, in an embodiment, can correspond an asset attribution and a root cause of the defects. For example, the asset linking module 130 can sort the asset attribution based on asset type and root cause of the defects. In an example, if the root cause is a track failure and the asset type is the rail at a particular location, the asset linking module 130 can associate the asset attribution and the root cause by storing the asset attribution information and the root cause based on metadata corresponding to the defects. For example, the metadata can include an identifier of the defects, a time stamp of the defects, the type of post, the technical group associated to the defects, or some other form of information storage based on metadata information.

The analytics module 132, in an embodiment, can perform analysis of at least one of the railway assets, defects, and projects based on data corresponding to the railway assets, defects, and projects. For example, the analytics module 132 can aggregate information corresponding to the railway assets, defects, and projects based on data or metadata of the information. In an example, the metadata can include an identifier of the railway assets, defects, and projects, a time stamp of the railway assets, defects, and projects, the type of post, the technical group, or some other form of information storage based on metadata information. The analytics module 132 can perform predictive analysis based on the aggregated information to predict a time frame when the railway assets, defects, and projects can be resolved. For example, the analytics module 132 can apply data analysis techniques to the aggregated data to identify trends associated with the railway assets, defects, and projects and a timeframe to resolve any issues. In an example, based on the data analysis techniques, the analytics module 132 can identify a likely time frame a technical group can resolve the issues. The data analysis techniques can include a best fit model to the aggregated data, a linear regression model, a neural network, or any other machine learning model applicable to the particular data analysis techniques. The data analysis techniques can include a threshold for determining one or more characteristics of the railway assets, defects, and projects. For example, the threshold can include a value constantly monitored against the data or metadata of the railway assets, defects, and projects. When the data or the metadata breach the threshold, the analytics module 132 can generate an alert the railway assets, defects, and projects require additional time to be resolved, requires another technical group to resolve the issues, or requires additional investigation to fully resolve the issues, etc.

The network access module 134, in an embodiment, can provide remote access to users over a network so any one of the users can update the information about at least one of the railway assets, defects, and projects in the collection of railway information in real time using a GUI. For example, the network access module 134 can identify a user based on collected information specific to the user including user credentials, user profile, and user department. For example, the network access module 134 can compare identifiers of the user to a known list of users allowed to access the network. In an example, the network access module 134 can establish a firewall between internal organizational communication and external internet access. The network access module 134 can anonymize the information based on various encryption methods. The network access module 134 can transmit and receive data as encrypted, unencrypted, over a VPN, or other suitable communication means. The encryption methods can include PGP, Blowfish, Twofish, 3DES, HTTPS, or other suitable encryption.

The status module 136, in an embodiment, can receive a response to a search result from one of the users based on a type of interaction. For example, the status module 136 can communicate with the GUI module 116 to receive inputs from the user. In an example, the status module 136 can receive an input from the GUI module 116 corresponding to a search from the user. The search can include information relevant to the collection of railway assets, defects, and projects. The status module 136 can parse the collection of railway information to determine a set of relevant search results corresponding to at least one of the railway assets, defects, and projects. In an example, the user can search for a keyword, such as “track,” to review search results associated with railway assets, defects, and projects related to the keyword. In another example, the status module 136 can automatically generate an updated status containing updated information corresponding to a status post by one of the users. For example, the status module 136 can communicate with the weather module 126. In an example, the status module 136 can receive an input from the weather module 126 corresponding to an update to at least one of the railway assets, defects, and projects. The status module 136 can update a network-facing notification indicating the update to the status of at least one of the railway assets, defects, and projects from the weather module 126.

The messaging module 138, in an embodiment, can transmit a message corresponding to the updated status to the users over the network in real time to enable an immediate access to up-to-date railway information. For example, the messaging module 138 can transmit the message to all of the accessible users within the network indicating the updated status of at least one of the railway assets, defects, and projects.

In one embodiment, the client device 175 can include a GPS receiver 140, a microprocessor 142, a wireless communication transceiver 144, and a display 146. The GPS receiver 140, microprocessor 142, wireless communication transceiver 144, and display 146 can implement one or more algorithms to facilitate communicating location data corresponding to a location of a user of the client device 175, including communication establishing, location identifying, and authentication managing algorithms. The algorithms can be programmable to suit particular railway events, application, function, facility, or other requirements. The client device 175 can be configured to receive communication signals, to and from the server. In another example, the client device 175 can generate one or more elements for display on the display 146. The elements can provide additional information related to the status of at least one of the railway assets, defects, and projects. For example, notifications can be generated by the client device 175 and displayed on the client to indicate network strength, location data collected, a direction of the client device 175 corresponding to cardinal directions, errors, or other suitable information. Additionally, system symbols can be displayed on the client to indicate task, inspection, or analysis status.

The GPS receiver 140, in an embodiment, can perform mathematical operations for estimating a position of the client device 175. The mathematical operations for estimating the position can include trilateration of the position based on location data received by the GPS receiver 140. For example, the location data can include information corresponding to a satellite constellation over the geographic location of the user. The GPS receiver 140 can use the location data to estimate a course location of the client device 175 based on known reference location information and a distance from the known reference location to the course location based on the location data. In an example, the course location can include a position of the client device. The known reference information can correspond to a locally stored reference position or calculated from a lag time of the time of flight for the location data. In an example, the GPS receiver 140 can coordinate the location data to a known pseudo-random code to identify a distance from the GPS constellation. In another example, the GPS receiver 140 can compensate for the lag time corresponding to the time of flight of the GPS signal using clock correction capabilities. The received location data can include digital information representing the geographic position of the client device 175. In an example, the location data can include latitude and longitude coordinates, GPS data, milepost marker information, line segment information, or another form of location data.

The microprocessor 142, in an embodiment, can communicate instructions corresponding to the operations of the client device 175. For example, in reference to the GPS receiver 140, the microprocessor 142 can receive the location data from the GPS receiver 140 and perform trilateration to determine the position of the user. In an example, the microprocessor 142 can be configured to include the known reference location. For example, the known reference location can include a lookup table associated to a known location to perform maintenance stored locally to the client device 175. In an example, the user can pre-program the microprocessor 142 with work maintenance location information for the microprocessor 142 to estimate the position of the client device 175 at any time. The microprocessor 142 can compensate for the motion of the client device 175 based on sensors providing signals to the client device 175. For example, the microprocessor 142 can receive movement information from an accelerometer in the client device 175 to determine a distance the client device 175 is from the work maintenance location. In an example, the microprocessor 142 can estimate the location using dead-reckoning techniques where the microprocessor 142 can calculate the distance traveled with the client device 175 away from the work maintenance location. In this way, the microprocessor 142 can estimate the position using of the client device 175.

In another example, the microprocessor 142 can receive an input from the display 146 indicating an interaction by the user. For example, the microprocessor 142 can receive machine-readable packet (i.e., a string of binary values) indicating the user interacted with the display 146 at a particular location. In another example, the input from the display 146 can be a mix of binary values corresponding to a particular icon displayed and the user interacts with. The microprocessor 142 can perform instructions in response to receiving the input from the display 146. For example, when the input corresponds to a location icon on the display 146, the microprocessor 142 can generate a communication packet indicating the position of the client device 175. The microprocessor 142 can transmit the communication packet to the display 146.

The wireless communication transceiver 144, in an embodiment, can transmit and receive wireless communication signals. The wireless communication transceiver 144 can establish communication links with network access points proximate to the client device 175. For example, the wireless communication transceiver 144 can communicate with a network. For example, the network can include satellite communications to the satellite constellation, long-range cellular communications, a Wi-fi network, a LAN, or any other type of wireless network appropriate for the geographic region. In an example, the wireless communication transceiver 144 can communicate with cellular towers using a common wireless communication protocol suitable for the geographic region. For example, the wireless communication transceiver 144 can incorporate a plurality of wireless communication capabilities able to transmit wireless signals at a plurality of frequencies. In an example, the wireless communication transceiver 144 can communicate with the cellular towers using a 3G, 4G, or 5G communication protocol, or another such protocol appropriate for the geographic region. In another example, the wireless communication transceiver 144 can establish a wireless connection with a Wi-fi network infrastructure.

The display 146, in an embodiment, can provide a digital representation of images, symbols, and text. For example, the display 146 can provide a digital representation of a geographic location-based interface on the client device 175. In an example, the display 146 can interact with the user. For example, the display 146 can provide touch-screen capabilities such that the user can interact with the display 146 and select particular icons. The display 146 can include a digitizer to convert physical touch of the user to an electrical signal and an information packet. For example, when the display 146 receives an input from the user, the digitizer of the display 146 can convert the touch into a string of binary values and communicate the interaction to the microprocessor 142 for further instructions. In another example, the display 146 can receive an input from the user indicating the user is to edit a location on the geographic location-based interface. In this manner, the display 146 can provide the digital representation of the geographic location-based interface such that the user can refine the position of the client device 175. For example, the display 146 can provide the geographic location-based interface in an expanded view to include a perspective of several states of the United States or a narrow view to include the estimated position of the client device 175 and landmarks proximate to the client device 175. For example, when the client device 175 is proximate to a segment of track along a railway corresponding to a particular line segment value or milepost marker, the display 146 can receive an input from the user to select a new position of the client device 175 such that the new position corresponds with the line segment or the milepost marker. In this manner, the display 146 can communicate the interaction with the user to other elements of the client device 175. For example, the display 146 can communicate the new position to the GPS receiver 140, microprocessor 142, and the wireless communication transceiver 144.

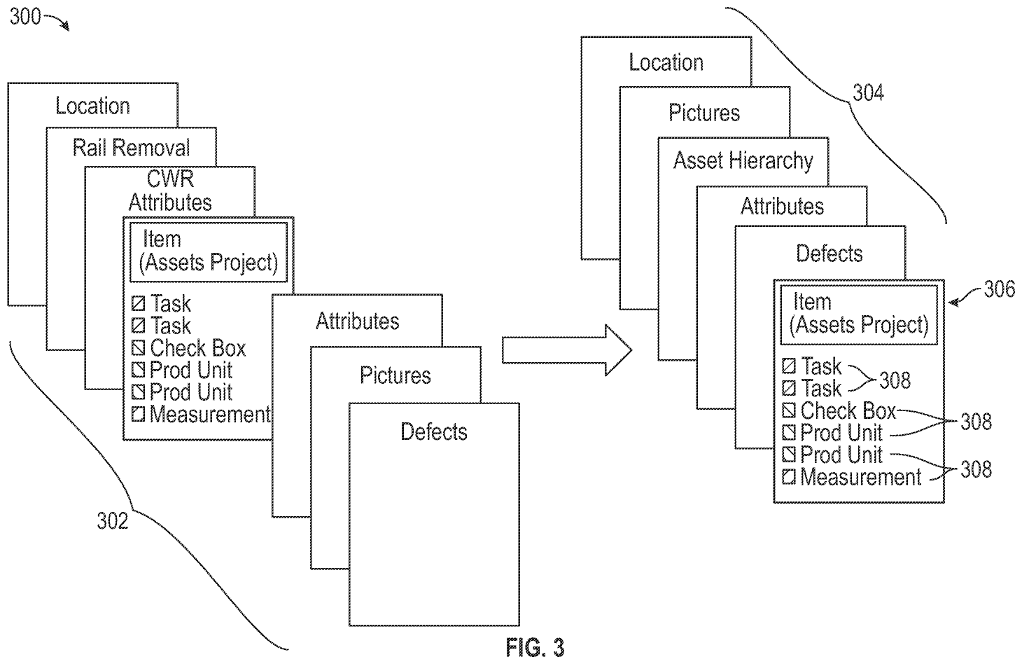

FIG. 3 illustrates a block diagram for an MWR system 300, in accordance with at least one embodiment of the present disclosure. The MWR system 300 can include a transformation from cluttered item organization 302 to streamlined user interface (UI) navigation 304, a production item 306, and production item categories 308. For example, the UI navigation 304 can follow basic outline with a menu design that allows department customization. In an example, certain steps can show on the UI navigation 304 based on what is selected on an interactive map. In another example, the production item 306 can include a standard set a question types to ask based on what is selected. For example, the standard set of question types can include Tasks in EAM, Production & Tasks, Measurements, Yes/No check box, etc. In another example, the MWR system 300 can process the aggregated information to transmit to a proper data storage. The cluttered item organization 302 can include independent software modules including location, rail removal, continuous welded rail (CWR) attributes, attributes, pictures, and defects. In this manner, a user parses through the various modules without organization to the MWR process. Alternatively, the UI navigation 304 can organize modules according to relevance for the MWR process.

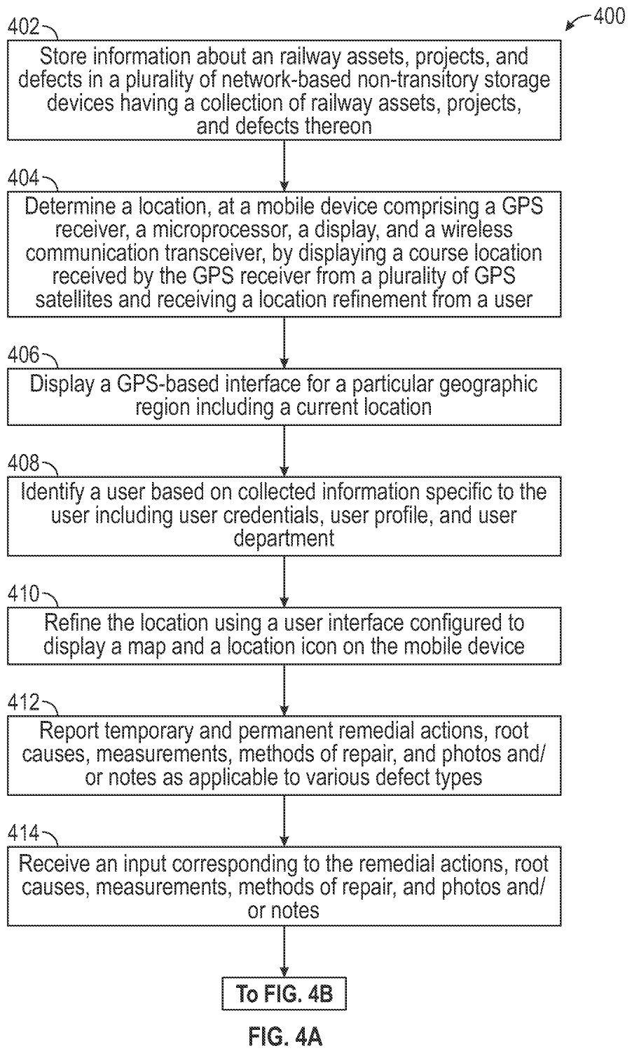

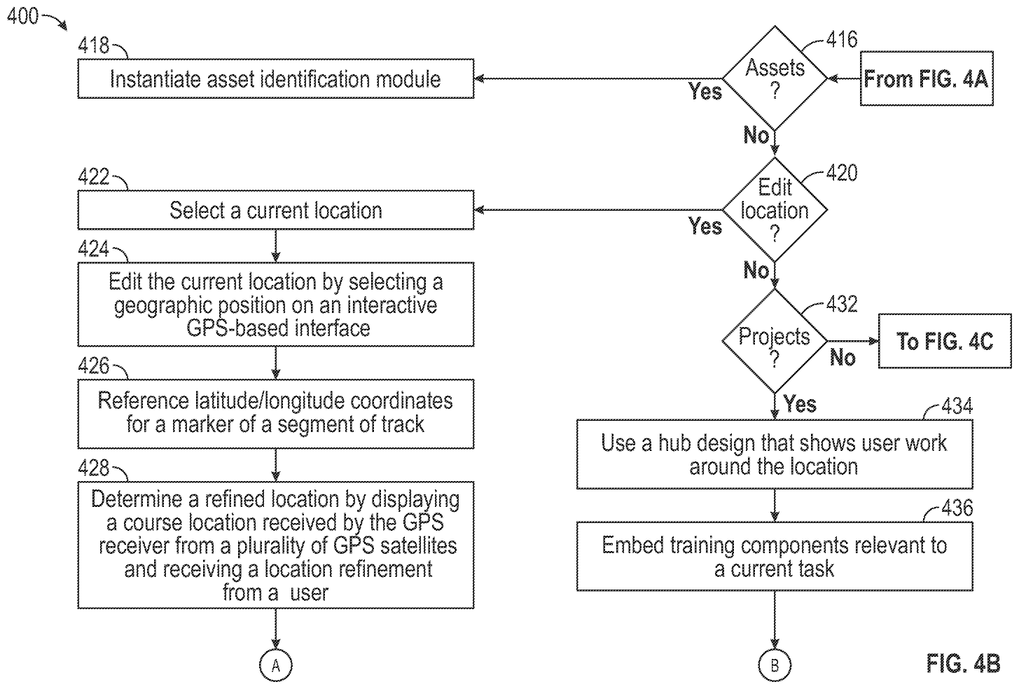

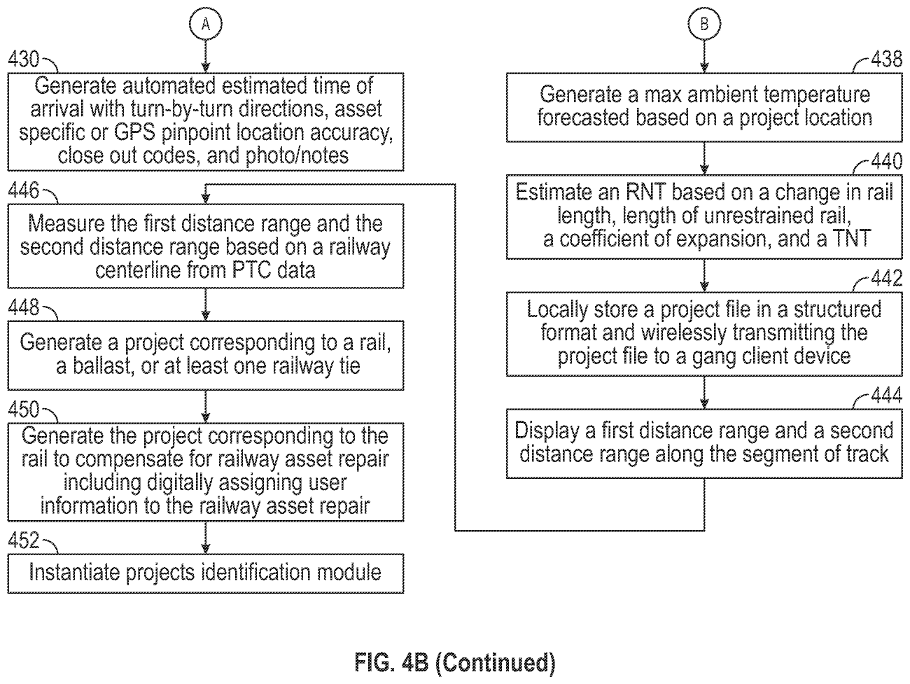

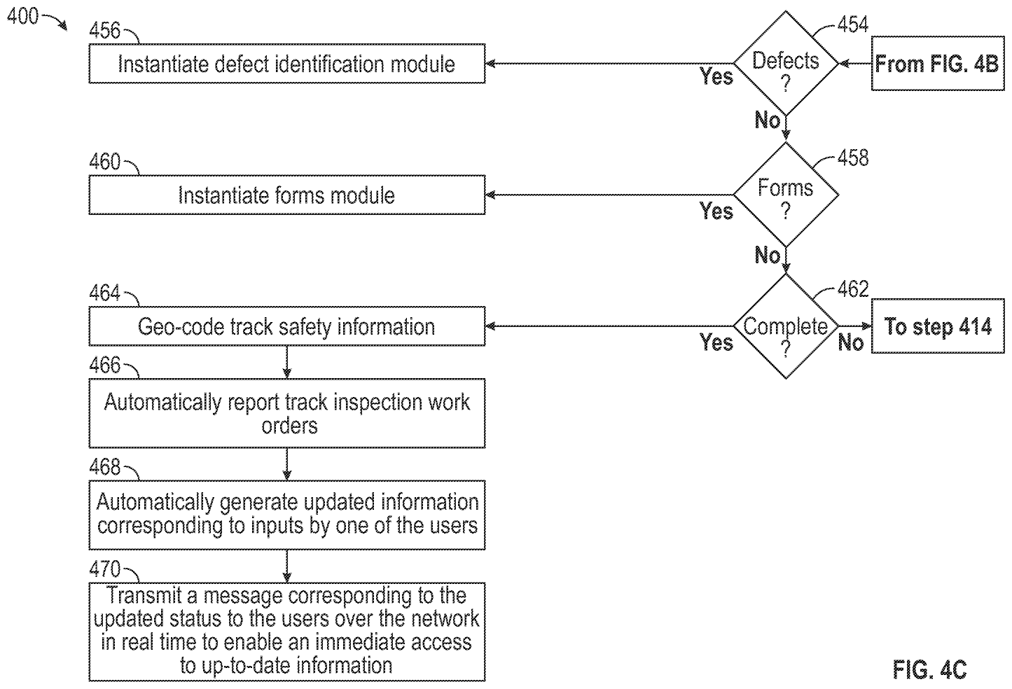

FIGS. 4A-4C illustrate a flowchart exemplifying MWR control logic 400, in accordance with at least one embodiment of the present disclosure. The MWR control logic 400 can be implemented as an algorithm on a computer processor (e.g., vital logic controller, microprocessor, FPGA, ASIC, server, etc.), a machine learning module, or other suitable system. Additionally, the MWR control logic 400 can be achieved with software, hardware, firmware, an API, a network connection, a network transfer protocol, HTML, DHTML, JavaScript, Dojo, Ruby, Rails, other suitable applications, or a suitable combination thereof. The MWR control logic 400 can interface electrical components to control mechanical components using logic processors.

In an embodiment, the MWR control logic 400 can interface with a memory for storing information about railway assets, defects, and projects in a plurality of network-based non-transitory storage devices having the collection of railway information thereon. Additionally, the MWR control logic 400 can interface the memory with a networked computer processor operably coupled to the memory and capable of executing machine-readable instructions to perform program steps. The MWR control logic 400 implementing hardware components (e.g., computer processor) can be capable of executing machine-readable instructions to perform program steps and operably coupled to a memory for storing the information about the railway assets, defects, and projects.

The MWR control logic 400 can leverage the ability of a computer platform to spawn multiple processes and threads by processing data simultaneously. The speed and efficiency of the MWR control logic 400 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 400 can also be distributed amongst a plurality of networked computer processors. The MWR control logic 400 of the present embodiment begins at step 402.

At step 402, in an embodiment, the control logic 400 can store information about the railway assets, projects, and defects in a plurality of network based non transitory storage devices having a collection of railway assets, projects, and defects thereon. For example, the information can include location data, weather information, status information, among other aspects critical to the railway assets, defects, and projects. In one embodiment, the control logic 400 can receive incoming messages from a network-operated server. For example, the incoming messages can correspond to one or more of the railway assets, defects, and projects, or a department of the corresponding technical group corresponding to the railway assets, defects, and projects. In another embodiment, the control logic 400 can transmit outgoing messages to the network-operated server. For example, the outgoing messages can request system component logs corresponding to one or more of the railway assets, defects, and projects. The control logic 400 then proceeds to step 404.

At step 404, in an embodiment, the control logic 400 can determine a location, at a mobile device comprising a GPS receiver, a microprocessor, a display, and a wireless communication transceiver, by displaying a course location received by the GPS receiver from a plurality of GPS satellites and receiving a location refinement from a user. In an example, the control logic 400 an receive a location of the client from the client. In another exemplary embodiment, the client can include a GPS radio to receive GPS signals and determine the location of the client from the received GPS signals. In another exemplary embodiment, the client can triangulate its location using two or more received signals via a radio operably coupled or embedded within the mobile device. In another exemplary embodiment, the client can determine its location using a Wi-Fi positioning system that can uses the characteristics of nearby Wi-Fi hotspots and other wireless access points to discover where the client is located. The client location can be transmitted to the control logic 400 via an encrypted network. For example, during a rail inspection, a user can begin inspecting a rail segment by beginning at a start point on a first end of the rail segment and capture a series of data points related to the segment. In order to begin logging the data related to an inspection, the user's location must first be determined. In one exemplary embodiment, the user's location can be identified by receiving one or more characteristics of the user's location (e.g., line segment, milepost location, etc.) or by utilizing the GPS functionality of the client. In another exemplary embodiment, once the GPS location (latitude and longitude coordinates) are determined, the control logic 400 can determine one or more characteristics of the user's location (e.g., line segment, milepost location, curve—high rail or low rail, etc.). In another exemplary embodiment, the GPS coordinates can determine the line segment and the mileposts by correlating the GPS coordinates with those stored in a GIS database. For example, a GIS database can include one or more rail segment characteristics associated with a particular latitude and longitude coordinate. The control logic 400 then proceeds to step 406.

At step 406, in an embodiment, the control logic 400 can display a GPS-based interface for a particular geographic region including a location of the railway assets, defects, and projects. In an example, the control logic 400 can display the GPS-based interface spanning the entire country or can display a local geographic region to the user. The control logic 400 can interact with the user allowing the user to search through various fields for an overview of all the relevant search results. The control logic 400 then proceeds to step 408.

At step 408, in an embodiment, the control logic 400 can identify a user based on collected information specific to the user including user credentials, user profile, and user department. For example, the control logic 400 can compare identifiers of the user to a known list of users allowed to access the network. The control logic 400 then proceeds to step 410.

At step 410, in an embodiment, the control logic 400 can refine the location using a user interface configured to display a map and a location icon on the mobile device. In an example, the control logic 400 can convert the interaction on the interface to a string of binary values segmented in various bit length sections. For example, each of the sections can include a particular number of bits corresponding to the type of interaction. For example, the interface for the user to respond on the GUI can include an indicator prompting the user to edit the location of the client device. The indicator can correspond to a plurality of bits. In an example, when the user interacts with the indicator to edit the location of the client device, the bit value corresponding to the indicator can be at least one binary value. In another example, the control logic 400 can incorporate a geographic location-based interface for the user to identify a new location for the client device. For example, the geographic location-based interface can include a map of the region surrounding the user for the user to identify the new location. In an example, the user can identify the new location by entering a location manually or for the control logic 400 to identify a location based on information from the client device with which the user is interacting. For example, the client device can transmit location-based information corresponding to the location of the client device to the control logic 400. The control logic 400 can identify the location and store the location of the client device locally or in an external data storage device. The control logic 400 then proceeds to step 412.

At step 412, in an embodiment, the control logic 400 can report temporary and permanent remedial actions, root causes, measurements, methods of repair, and photos and/or notes as applicable to various defect types. For example, the control logic 400 can transmit any information corresponding to the railway assets, defects, and projects and the remedial actions to a remote network-based server. The control logic 400 can structure a message to transmit to the server such that the server can parse and store the information accordingly. The control logic 400 then proceeds to step 414.

At step 414, in an embodiment, the control logic 400 can receive an input corresponding to the remedial actions, root causes, measurements, methods of repair, and photos and/or notes. For example, the control logic 400 can interact with the user through a GUI. The control logic 400 can receive the input in the form of a physical contact with a client device operating the GUI. In another example, the control logic 400 can receive a click from the user as the input to identify the remedial actions, root causes, measurements, methods of repair, and photos and/or notes. The control logic 400 then proceeds to step 416.

At step 416, in an embodiment, the control logic 400 can determine whether the response type is an assets type of interaction. For example, the control logic 400 can associate an interaction with an assets icon on a display with the assets type of interaction. The interaction can correspond to the user requesting to include details about the railway asset to upload to the network of users. In another example, the control logic 400 can receive a notification from the network indicating relevant railway assets associated to the user based on the user ID. If the response type is the assets type of interaction, the control logic 400 then proceeds to step 418. If the response type is not the assets type of interaction, the control logic 400 then proceeds to step 420.

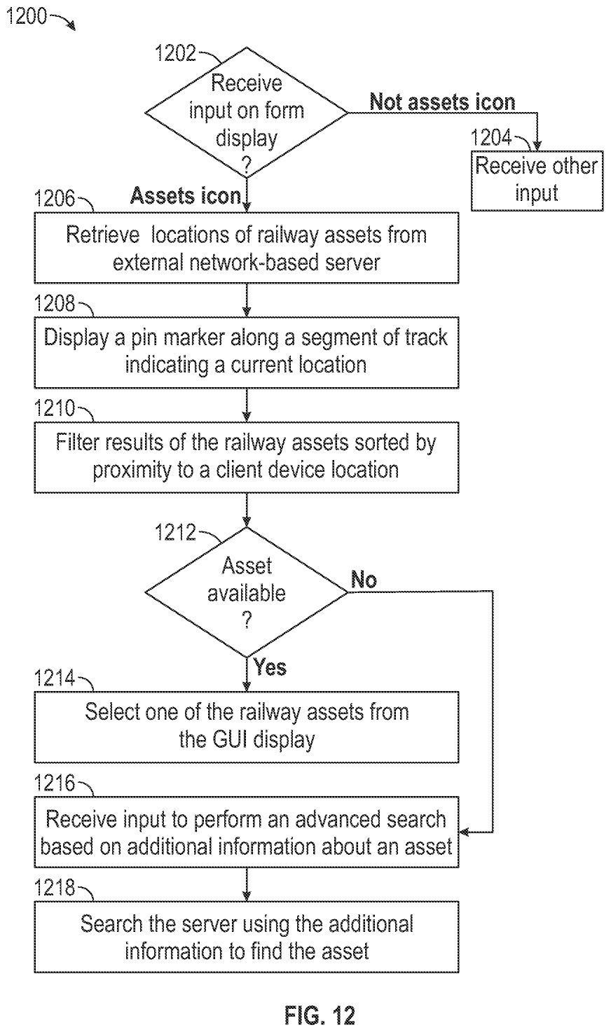

At step 418, in an embodiment, the control logic 400 can instantiate an asset identification module. For example, the control logic display in FIG. 12.

At step 420, in an embodiment, the control logic 400 can determine whether the response type is an edit location type of interaction. For example, the control logic 400 can associate an interaction with an edit location icon on a display with the edit location type of interaction. The interaction can correspond to the user requesting to update the network about a current location of the client device, the assets, the defects, the project locations, etc. If the response type is the edit location type of interaction, the control logic 400 then proceeds to step 422. If the response type is not the edit location type of interaction, the control logic 400 then proceeds to step 432.

At step 422, in an embodiment, the control logic 400 can select a current location. For example, the control logic 400 can select the location of the railway assets, defects, and project positions. In an example, the control logic 400 can convert the interaction on the interface to a string of binary values segmented in various bit length sections. For example, each of the sections can include a particular number of bits corresponding to the type of interaction. For example, the interface for the user to respond to the GUI can include an indicator prompting the user to select the location of the railway assets, defects, and project positions. The indicator can correspond to a plurality of bits. In an example, when the user interacts with the indicator to select the location of the railway assets, defects, and project positions, the bit value corresponding to the indicator can be at least one binary value. In another example, the control logic 400 can incorporate a geographic location-based interface for the user to identify the location for the railway assets, defects, and project positions. For example, the geographic location-based interface can include a map of the region surrounding the user for the user to identify the new location. In an example, the user can identify the location by entering a location manually or for the control logic 400 to identify a location based on information from the client device with which the user is interacting. For example, the client device can transmit location-based information corresponding to the location of the client device to the control logic 400. The control logic 400 can identify the location and store the location of the client device locally or in an external data storage device. The control logic 400 then proceeds to step 424.

At step 424, in an embodiment, the control logic 400 can edit the current location by selecting a geographic position on an interactive GPS based interface. In an example, the control logic 400 can convert the interaction on the interface to a string of binary values segmented in various bit length sections. For example, each of the sections can include a particular number of bits corresponding to the type of interaction. For example, the interface for the user to respond to the GUI can include an indicator prompting the user to edit the location of the railway assets, defects, and project positions. The indicator can correspond to a plurality of bits. In an example, when the user interacts with the indicator to edit the location of the railway assets, defects, and project positions, the bit value corresponding to the indicator can be at least one binary value. In another example, the control logic 400 can incorporate a geographic location-based interface for the user to identify a new location for the railway assets, defects, and project positions. For example, the geographic location-based interface can include a map of the region surrounding the user for the user to identify the new location. In an example, the user can identify the new location by entering a location manually or for the control logic 400 to identify a location based on information from the client device with which the user is interacting. For example, the client device can transmit location-based information corresponding to the location of the client device to the control logic 400. The control logic 400 can identify the location and store the location of the client device locally or in an external data storage device. The control logic 400 then proceeds to step 426.

At step 426, in an embodiment, the control logic 400 can reference latitude/longitude coordinates for a marker of a segment of track. For example, the control logic 400 can receive manual input from the user corresponding to the latitude/longitude coordinates for the railway assets, defects, and project positions. The control logic 400 then proceeds to step 428.

At step 428, in an embodiment, the control logic 400 can determine a refined location by displaying a course location received by the GPS receiver from a plurality of GPS satellites and receiving a location refinement from a user. For example, the control logic 400 can identify the refined position of the client device based on location data from a GPS receiver and a pin marker identifying the refined position on the geographic location-based interface. In an example, the control logic 400 can receive input from the user to modify the current location. For example, the control logic 400 can identify the refined position with reference to known location parameters from the GPS receiver. In an example, the control logic 400 can reference the position of the pin marker on the geographic location-based interface with physical locations proximate to the position of the client device. For example, the control logic 400 can interface with the GPS receiver such that the GPS receiver provides location data of the physical locations proximate to the client device. The control logic 400 can transmit the refined position of the client device. In this manner, the control logic 400 can receive the input from the user in the form of the user interacting with the location-based interface by touching and sliding the pin marker to a refined location.

In another example, the control logic 400 can generate the pin marker for the user to interact with the geographic location-based interface. The pin marker can correspond to a plurality of bits. In an example, when the user interacts with the pin marker to refine the location of the user, the bit values corresponding to the pin marker can include a plurality of binary values. For example, the control logic 400 can receive the refined location in response to the user interacting with the geographic location-based interface of the GUI. In an example, the refined location can include refined location data to pinpoint where the user is located. The refined location data can include a manual identification on a map using an icon to reference the location of the user, latitude and longitude coordinates of the location of the user, a line segment of the segment of track, a milepost marker of the segment of track, or another form of location data to indicate the refined location of the user. The control logic 400 then proceeds to step 430.

At step 430, in an embodiment, the control logic 400 can generate automated estimated time of arrival with turn by turn directions, asset specific or GPS pinpoint location accuracy, close out codes, and photo/notes. For example, the control logic 400 can identify a direct route from the location of the user to the location of the railway asset, defect, or project based on railway track location information. For example, the control logic 400 can identify a route from the location of the client device to the location of the railway asset, defect, or project. The route can include a plurality of routes based on a variety of methods of transportation. For example, the route can include directions based on traveling by road or traveling by rail. In an example, the route for traveling by rail can include directions for the user to travel by high rail, where an automobile can travel along the railway.

At step 432, in an embodiment, the control logic 400 can determine whether the response type is a projects type of interaction. For example, the control logic 400 can associate an interaction with a projects icon on a display with the projects type of interaction. The interaction can correspond to the user requesting to update the network about a status of the projects. If the response type is the projects type of interaction, the control logic 400 then proceeds to step 434. If the response type is not the projects type of interaction, the control logic 400 then proceeds to step 454.

At step 434, in an embodiment, the control logic 400 can use a hub design that shows user work around the location. For example, the control logic 400 can query an external network-based server for proximate work within a predetermined distance away from the refined location. In an example, the control logic 400 can query the server using location data from the GPS receiver. For example, the control logic 400 can receive location data corresponding to the location of the client device. The location of the client device can correspond to a pin marker displayed as part of a geographic location-based interface on the client device. The control logic 400 can receive the query including the location of the client device. The control logic 400 can identify the location of the client device and organize work based on a proximity of the work locations to the location of the client device. For example, the control logic 400 can refine search results of the work locations based on a proximity threshold. The proximity threshold can include a distance value away from the location of the client device considered relevant to the location of the client device. In an example, the refined location can be constrained by a physical display of the client device in response to an input by the user. The control logic 400 then proceeds to step 436.

At step 436, in an embodiment, the control logic 400 can embed training components relevant to a current task. For example, the control logic 400 can identify the user to a particular technical department and to a particular railway gang. The intersection of the work corresponding to the particular technical group, particular railway gang, and the user can filter the projects associated to the user. From the filtered work, the control logic 400 can identify training components relevant to the current task based on information from the external server. For example, the control logic 400 can receive common training components to resolve comparable tasks to the current task. The control logic 400 can display the training components corresponding to the current task on the GUI such that the user can determine appropriate process to resolve the current task. The control logic 400 then proceeds to step 438.

At step 438, in an embodiment, the control logic 400 can generate a max ambient temperature forecasted based on a project location. For example, the control logic 400 can interface with a weather API. The control logic 400 can receive weather data corresponding to a location of the railway asset, defect, or project. The control logic 400 can identify a weather forecast for the location. The weather forecast can include a series of high temperature values and a series of low temperature values. In an example, the control logic 400 can calculate the max ambient temperature based on the weather forecast. For example, the control logic 400 can add the high values of the weather forecast for a duration of the work to be completed and divide by the duration to determine the max ambient temperature. The control logic 400 then proceeds to step 440.

At step 440, in an embodiment, the control logic 400 can estimate a rail neutral temperature (RNT) based on a change in rail length, length of unrestrained rail, a coefficient of expansion, and a track neutral temperature (TNT). For example, the RNT can be calculated based on the following equation:

$$RNT = TNT - \frac{RL}{α * L * 12}$$

Where RL is the change in rail length (in inches), α is the coefficient of expansion, L is the length of unrestrained rail. The control logic 400 then proceeds to step 442.

At step 442, in an embodiment, the control logic 400 can locally store a project file in a structured format and wirelessly transmitting the project file to a gang client device. For example, the control logic 400 can generate a file to store the project file locally. In an example, the file can include a JSON format, XML format, SQL format, or another form of structured formatting for transmitting the file. The project file can include predetermined information relevant to a type of project for the project file and inputs from the user. For example, the control logic 400 can receive the inputs from the user and store the inputs in the project file. In another example, the control logic 400 can transmit the project file to the gang client device via a wireless communication link. For example, the wireless communication link can include Bluetooth™ Apple™ AirDrop™, or another form of wireless file transfer between devices. The control logic 400 then proceeds to step 444.

At step 444, in an embodiment, the control logic 400 can display a first distance range and a second distance range along the segment of track. The control logic 400 then proceeds to step 446.

At step 446, in an embodiment, the control logic 400 can measure the first distance range and the second distance range based on a railway centerline from PTC data. For example, the control logic 400 can receive PTC data identifying a railway centerline. The control logic 400 can correlate the PTC data to the locations of the first distance range and the second distance range. In this manner, the control logic 400 can identify rail distance measurements of the segment of track. The control logic 400 then proceeds to step 448.

At step 448, in an embodiment, the control logic 400 can generate a project corresponding to a rail, a ballast, or at least one railway tie. For example, the control logic can generate a project file corresponding to the project. The control logic 400 then proceeds to step 450. In an example, the control logic 400 can generate the project corresponding to the rail to compensate for railway asset repair including digitally assigning user information to the railway asset repair. The control logic 400 then proceeds to step 452.

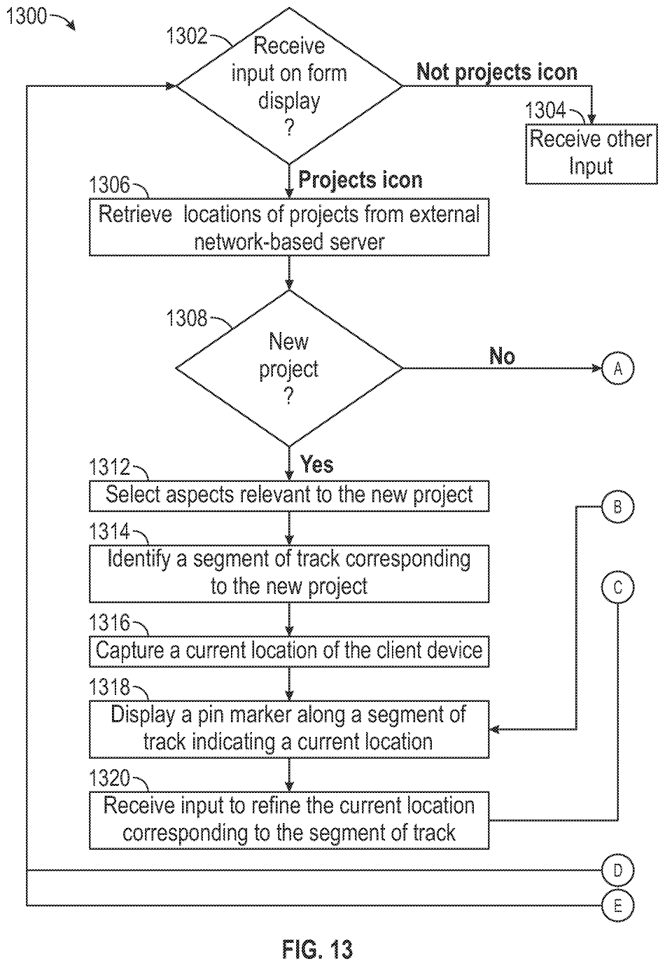

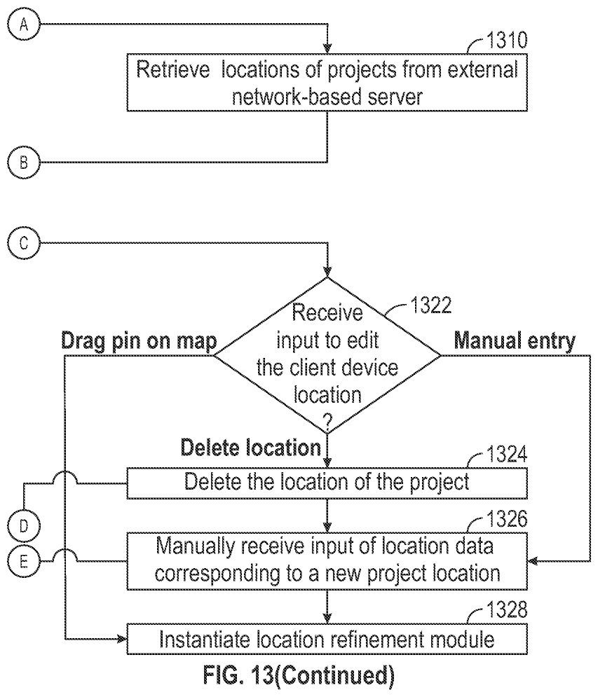

At step 452, in an embodiment, the control logic 400 can instantiate a projects identification module. For example, the control logic in FIG. 13.

At step 454, in an embodiment, the control logic 400 can determine whether the response type is a defects type of interaction. For example, the control logic 400 can associate an interaction with a response details icon on a display with the response details type of interaction. The interaction can correspond to the user requesting to include details about the defects to upload to the network of users. If the response type is the defects type of interaction, the control logic 400 then proceeds to step 456. If the response type is not the defects type of interaction, the control logic 400 then proceeds to step 458.

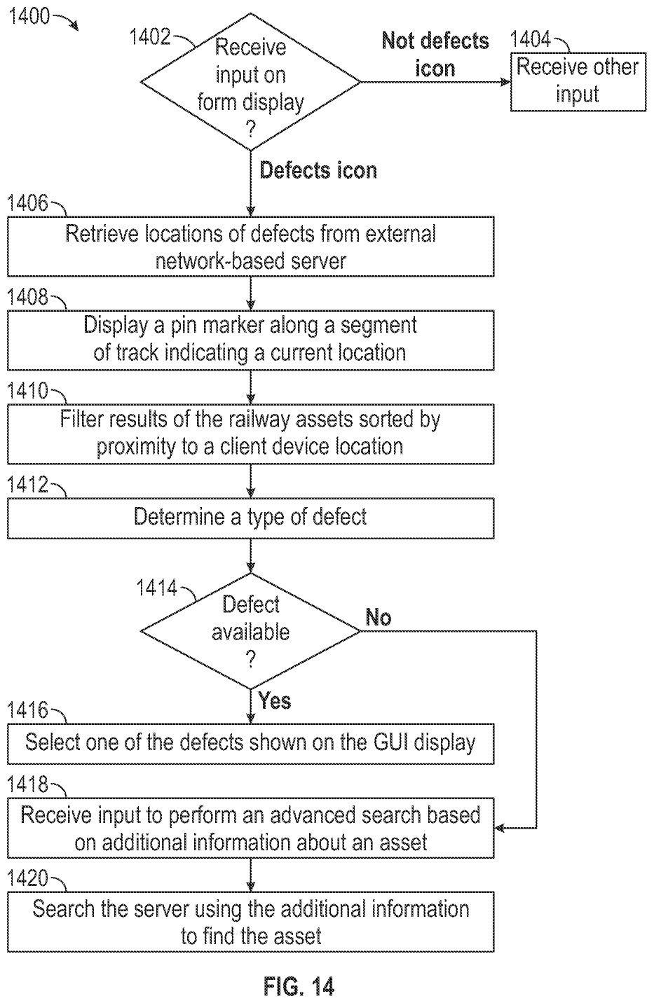

At step 456, in an embodiment, the control logic 400 can instantiate a defect identification module. For example, the control logic in FIG. 14.

At step 460, in an embodiment, the control logic 400 can determine whether the response type is a completed type of interaction. For example, the control logic 400 can associate an interaction with a completed icon on a display with the completed type of interaction. The interaction can correspond to the user requesting to include details about the railway asset, defect, or project to upload to the network of users. If the response type is the completed type of interaction, the control logic 400 then proceeds to step 462. If the response type is not the completed type of interaction, the control logic 400 then proceeds to step 414.

At step 462, in an embodiment, the control logic 400 can geo-code track safety information. For example, the geo-coded information can include a communication packet generated such that the components of the packet include location-based information corresponding to the current location. In an example, the geo-coded information can correspond to a segment of track proximate to the client device. In another example, the control logic 400 can transmit the geo-coded information to the satellite constellation, the network-based server, the wireless communications tower. In an example, the communication packet can include a location-based identifier as a header of the packet. In another example, the geo-coded information can include location identifying information such as the latitude and longitude of the current location. In an example, the control logic 400 can transmit information from the location data indicating the location of the user. The location data can include various location identifier such as geographic triangulation based on network architecture hardware. For example, the location data can correspond to communications between the client device and a wireless network. The control logic 400 then proceeds to step 464.

At step 464, in an embodiment, the control logic 400 can automatically report track inspection work orders. For example, the control logic 400 can transmit at least one project file corresponding to the track inspection work orders. The control logic 400 can transmit the project file to the network server. In this manner, the control logic 400 can update the network server about the track inspection work orders in real-time. In an example, the control logic 400 can transmit the project file when the control logic 400 identifies sufficient network connection. The control logic 400 then proceeds to step 466.

At step 466, in an embodiment, the control logic 400 can automatically generate an updated status containing updated information corresponding to a status post by one of the users. For example, the control logic 400 can receive an input corresponding to an update to at least one of the railway assets, defects, and projects. The control logic 400 can update a network-facing notification indicating the update. The control logic 400 then proceeds to step 468.

At step 468, in an embodiment, the control logic 400 can transmit a message corresponding to the updated status to the users over the network in real time to enable an immediate access to up-to-date information. For example, the control logic 400 can transmit the message to all of the accessible users within the network indicating the updated status.

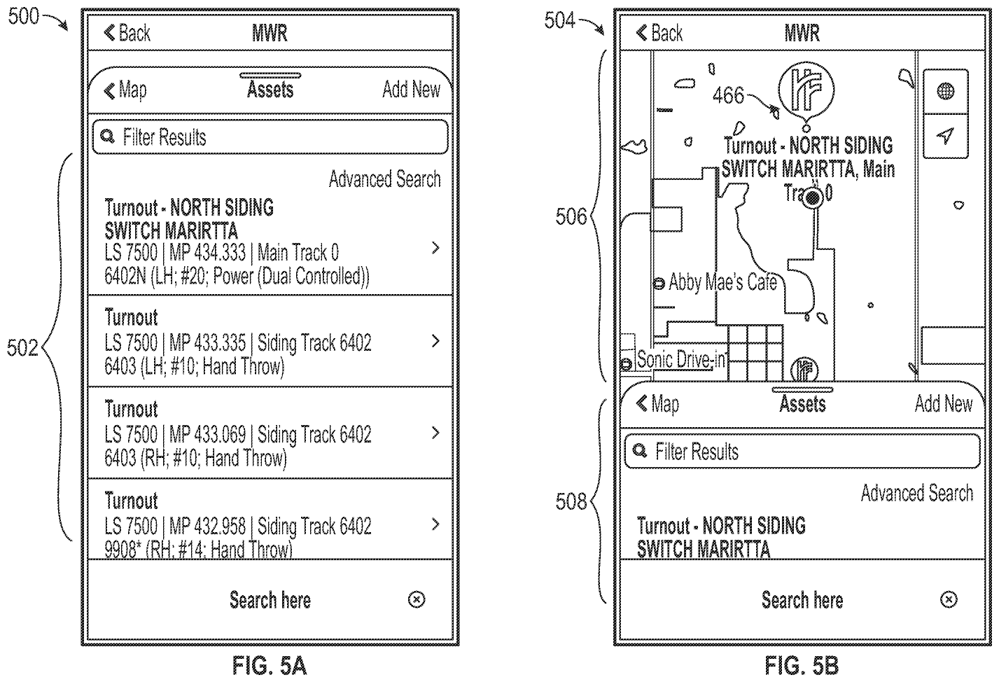

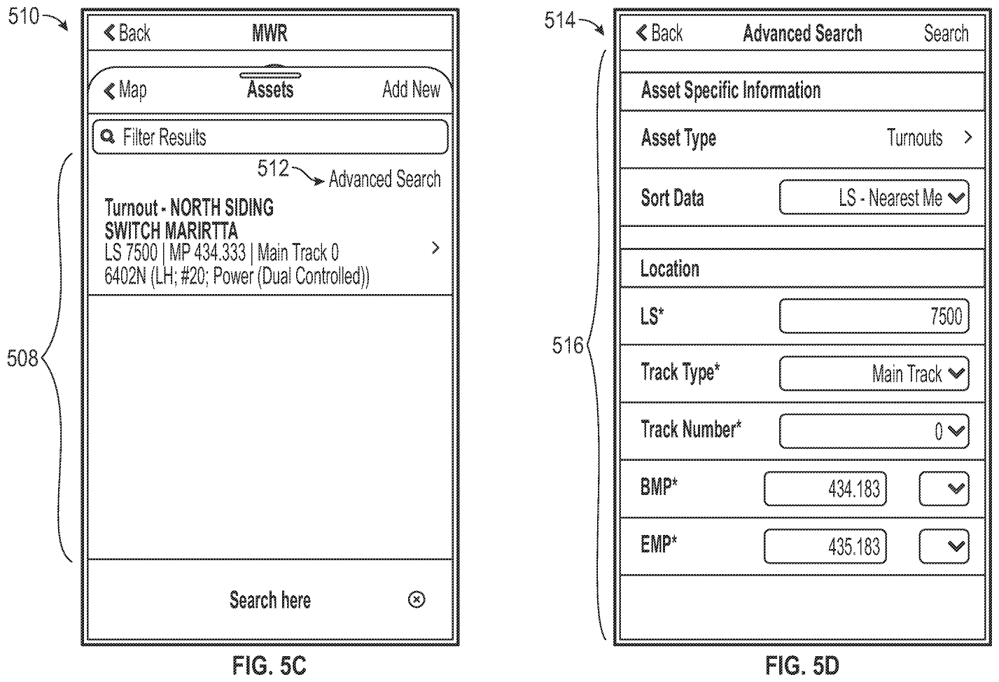

FIGS. 5A-5D illustrate an MWR assets interface, in accordance with one or more exemplary embodiments of the present disclosure. Referring to FIG. 5A, an assets screen 500 can include a plurality of search results 502 indicating open assets requiring maintenance. Referring to FIG. 5B, an asset display screen 504 can include the assets displayed on an interactive map screen 506. The interactive map screen 506 can include at least one asset location 466. The asset display screen 504 can include an asset information display 508 to display information about a selected asset. Referring to FIG. 5C, a selected asset screen 510 can include the asset information display 508. The selected asset screen 510 can include an advanced search function 512 allowing the user to search a database of available assets based on more specific information. Referring to FIG. 5D, an advanced search screen 514 can include advanced search information fields 516 to further specify the information by which to search the database of available assets to refine search results. For example, the advanced search screen 514 can include asset specific information such as an asset type and a manner in which to sort data from the database. The advanced search screen 514 can include location information such as a line segment (LS), a track type, a track number, a beginning mile post value, and an end mile post value.

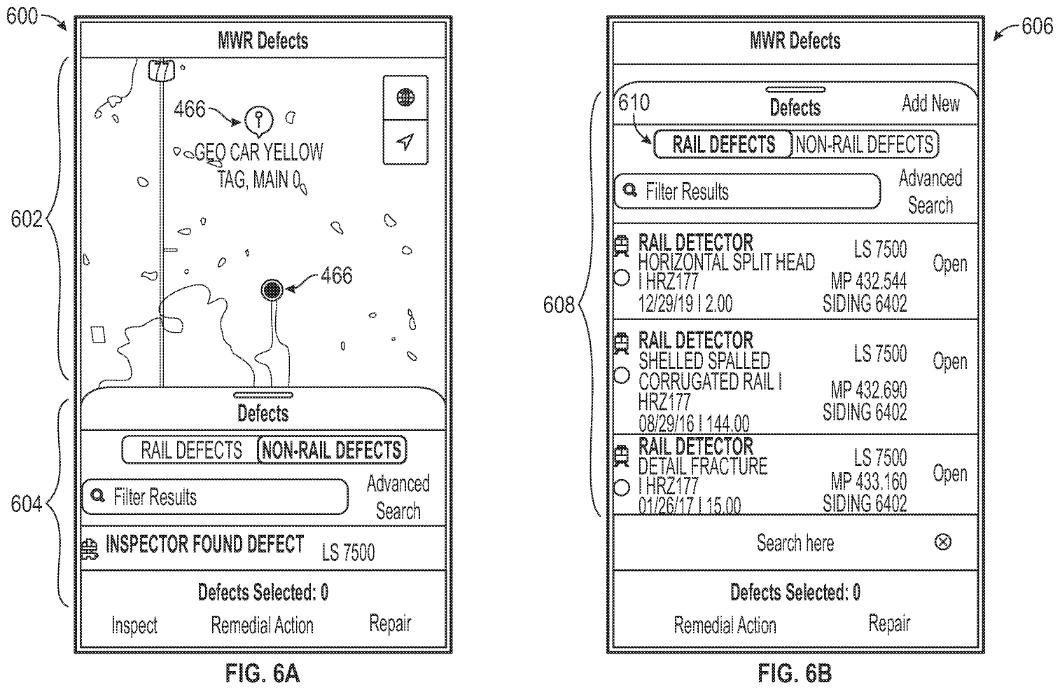

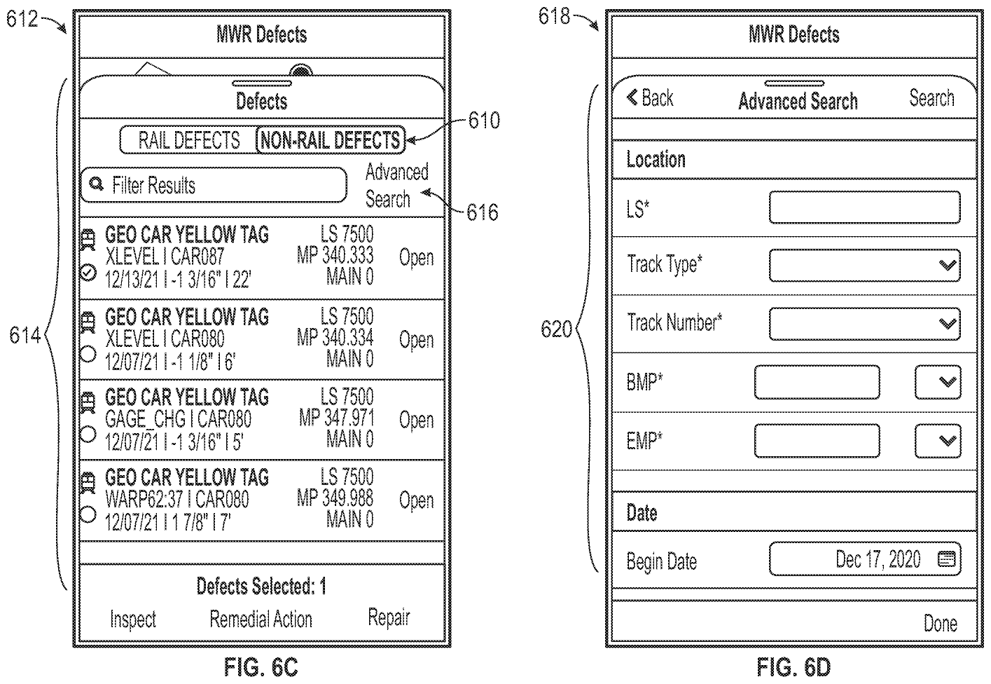

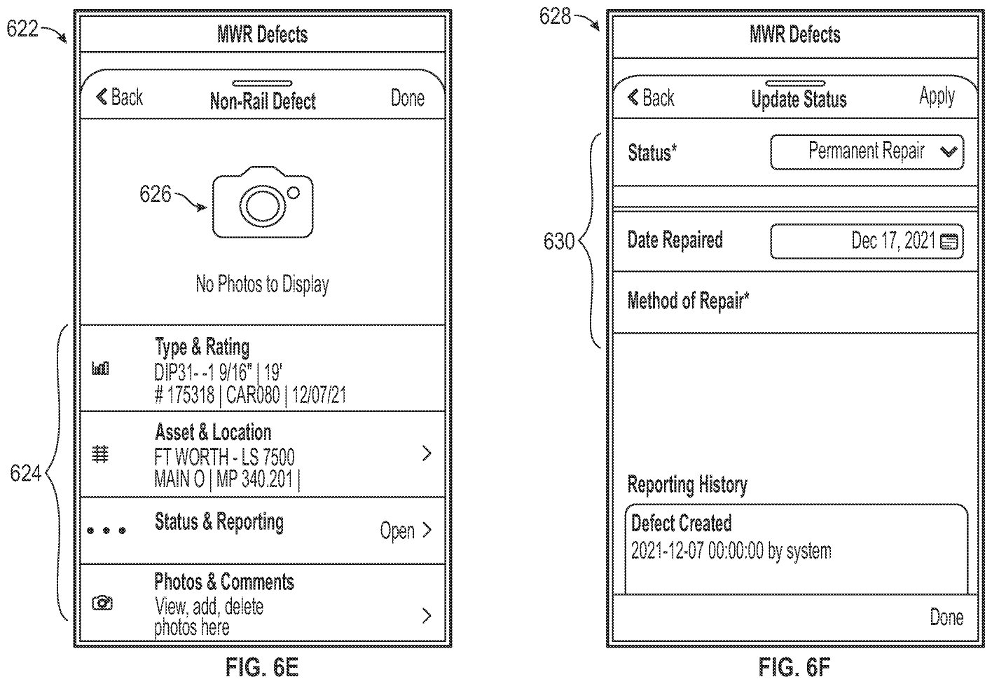

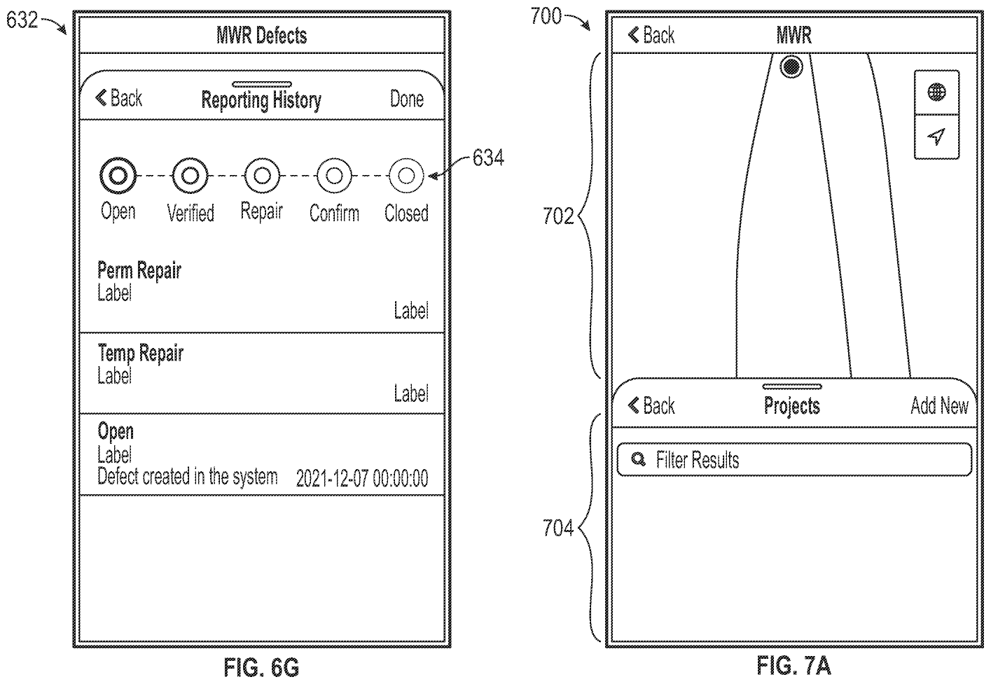

FIGS. 6A-6G illustrate MWR defects interface, in accordance with one or more exemplary embodiments of the present disclosure. Referring to FIG. 6A, a defects screen 600 can include an interactive map screen 602 including various geographic points 466. The defects screen 600 can include a list of defects 604. The list of defects 604 can be sorted by either rail defects or non-rail defects. The list of defects 604 can include defect information, such as location, description, date of defect, among other fields of information relevant for the defect. Referring to FIG. 6B, an updated defects screen 606 can include a list of rail defects 608 in response to toggling a defect sort button 610. Referring to FIG. 6C, an updated list of defects 612 can include a plurality of non-rail defects 614 sorted based on proximity to a user. For example, the first result of the plurality of non-rail defects 614 can include a closest defect to a client device location. The updated list of defects 612 can include an advanced search function 616 allowing a user to search a database of defects using granular information. Referring to FIG. 6D, an advanced search screen 618 can include a plurality of advanced search input fields 620. The plurality of advanced search input fields 620 can include line segment, track type, track number, beginning mile post marker, end mile post marker, among other relevant search characteristics. Referring to FIG. 6E, a non-rail defect screen 622 can include a photo position 626 to provide a user photo. The non-rail defect screen 622 can include information fields corresponding to the non-rail defect. For example, the non-rail defect screen 622 can include a type and rating value for whatever is worked on. In another example, the non-rail defect screen 622 can include an asset location value, a status and reporting. Referring to FIG. 6F, an update status screen 628 can include update status information fields 630 to update information corresponding to a particular update status. Referring to FIG. 6G, a reporting history screen 632 can visually display a progress illustration 634. The progress illustration 634 can include colors coordinating to a degree of completion of the project.

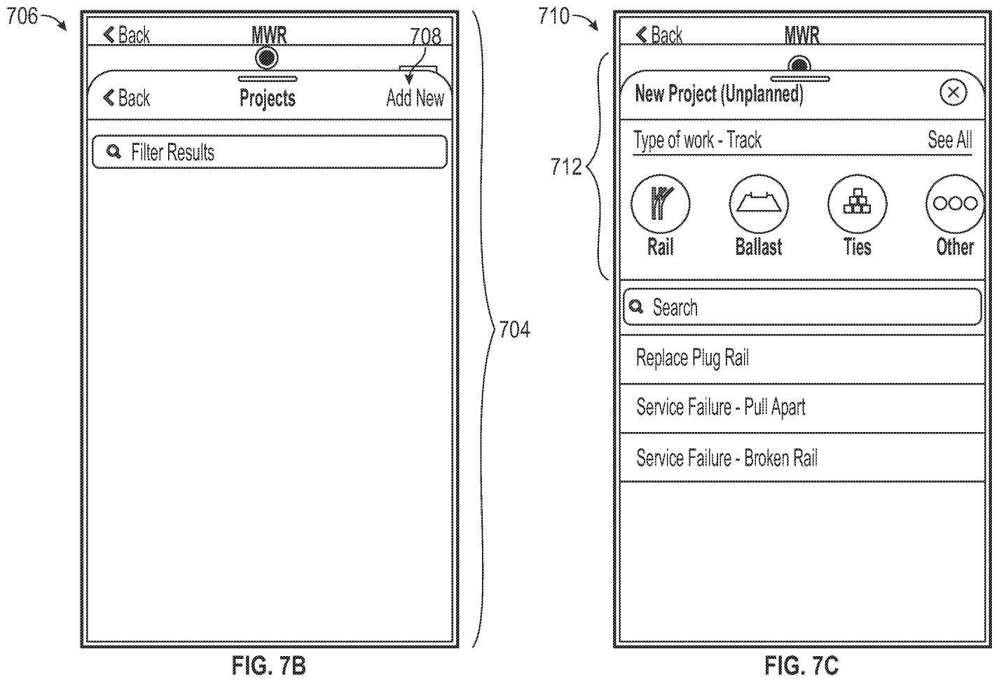

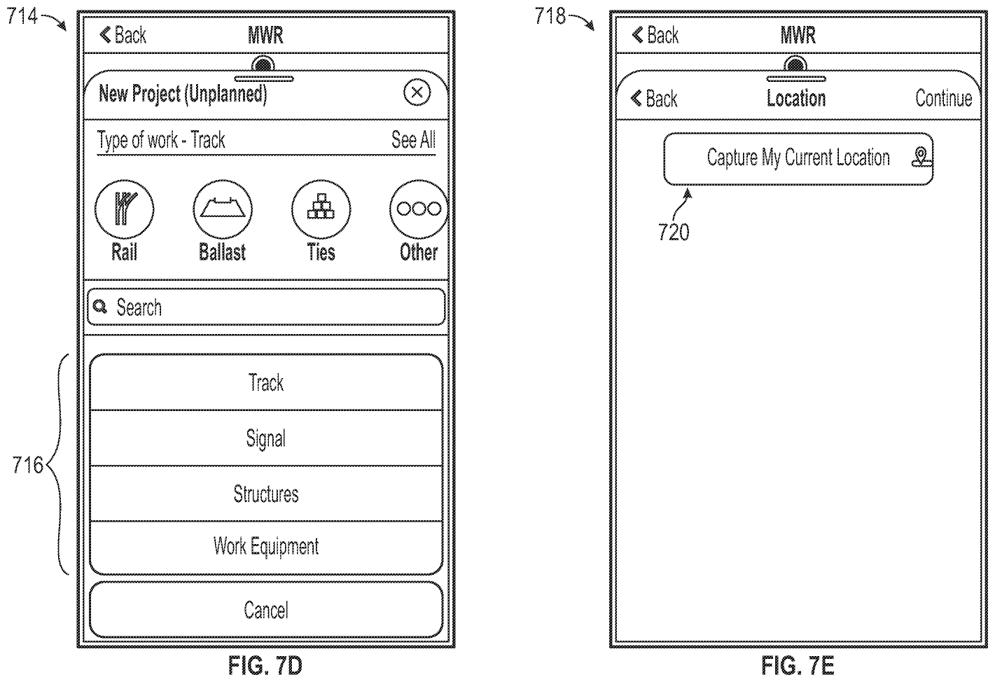

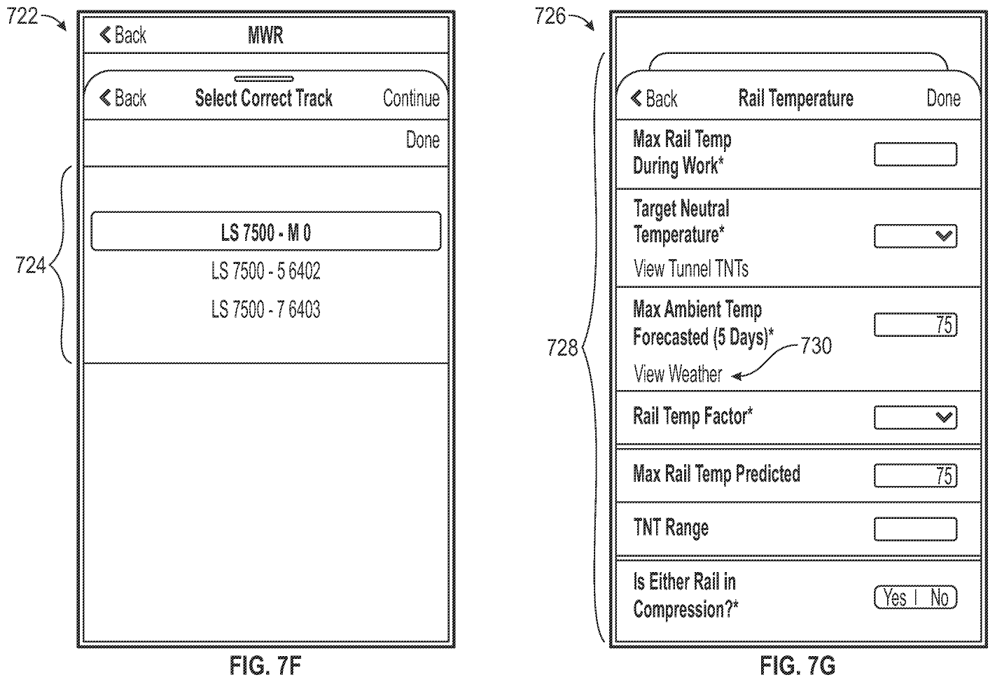

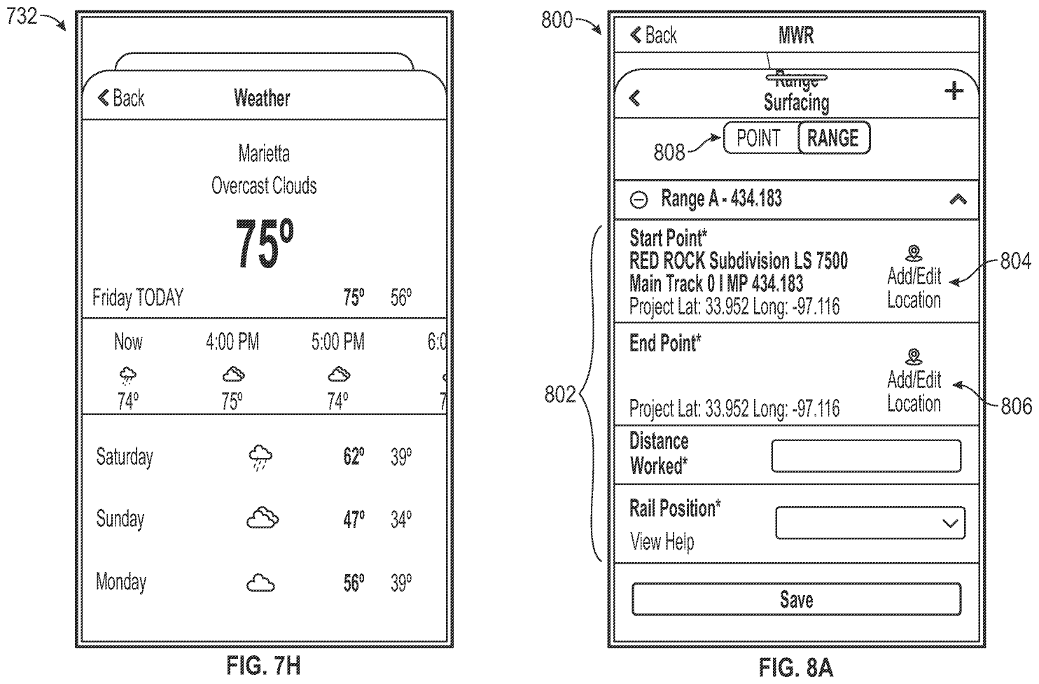

FIGS. 7A-7H illustrate an MWR projects interface, in accordance with one or more exemplary embodiments of the present disclosure. Referring to FIG. 7A, a projects screen 700 can include an interactive map screen 702. The projects screen 700 can include a list of projects 704. Referring to FIG. 7B, a project display screen 706 can include the list of projects 704. In an example, the list of projects 704 can include nothing. Alternatively, the list of projects 704 can include all available projects for a user to review. The project display screen 706 can include an add new button 708 to generate a new project. Referring to FIG. 7C, new project screen 710 can include a new project type 712. The new project type 712 can include a rail, ballast, tie, or some other rail-related project type. Referring to FIG. 7D, a selected project screen 714 can include refined project types 716 to specify a technical department the project can belong. For example, the refined project types 716 can include a track, signal, structures, and work equipment. Referring to FIG. 7E, a project location screen 718 can include a capture my location button 720. The capture my location button 720 can use a GPS receiver of the client device to identify a current location of the client device to determine proximate railway track marker. Referring to FIG. 7F, a correct track screen 722 can include a plurality of proximate track markers 724. The plurality of proximate track markers can guide the user to select an appropriate track marker to associate to the project. Referring to FIG. 7G, a rail temperature screen 726 can include rail temperature input fields 728. The rail temperature input fields 728 can receive input either manually from the user or automatically based on an API call to a weather API. For example, the temperature input fields 728 can retrieve the temperature information from a weather API. The rail temperature screen 726 can include a view weather button 730 to display a weather forecast for the project location. Referring to FIG. 7H, a weather screen 732 can display the weather forecast for the project location.

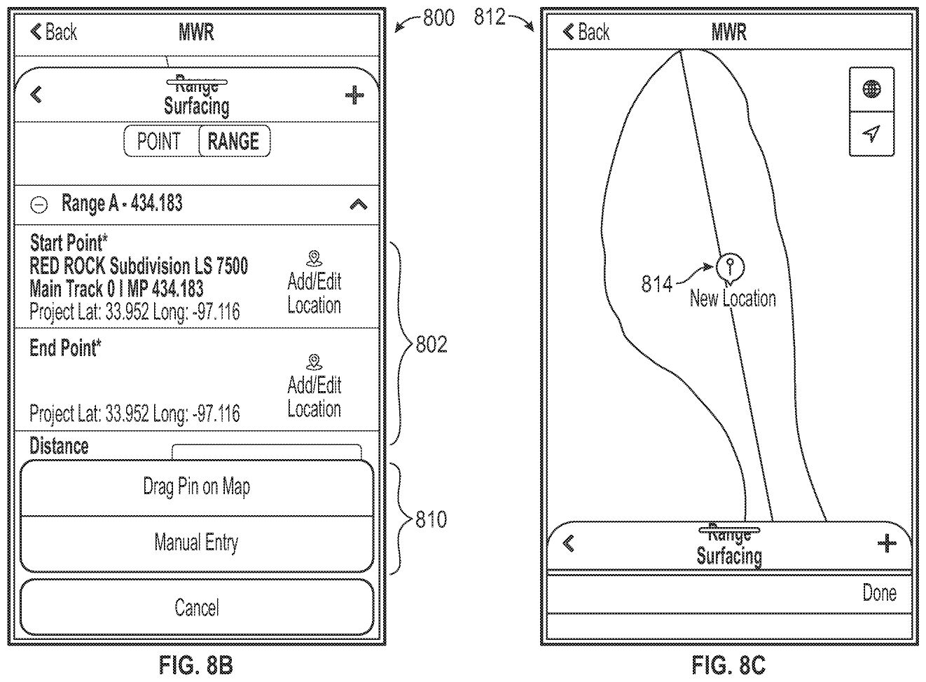

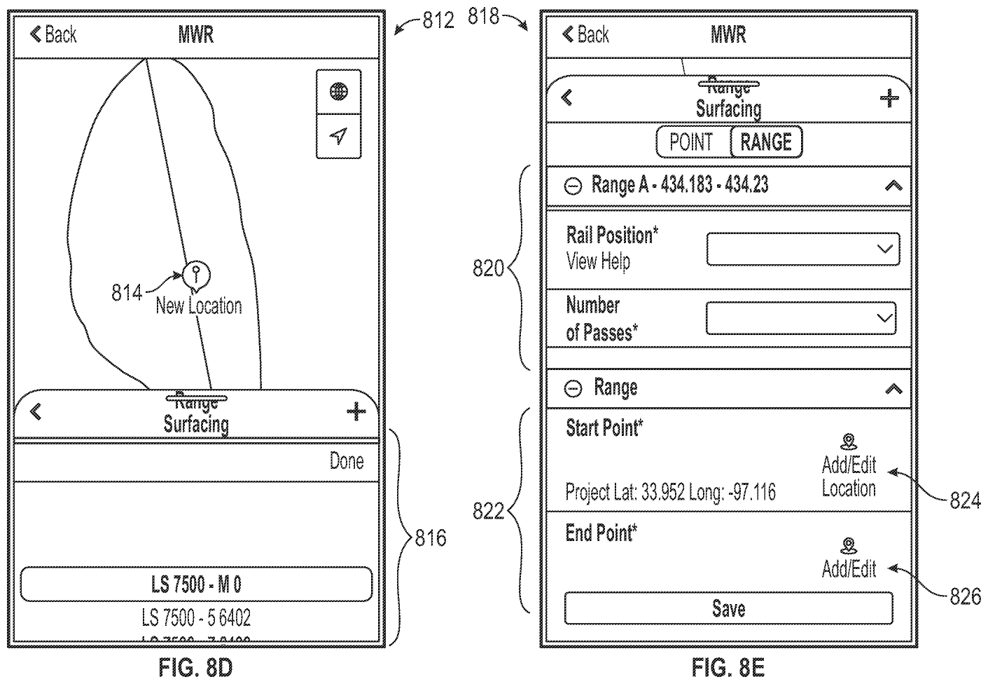

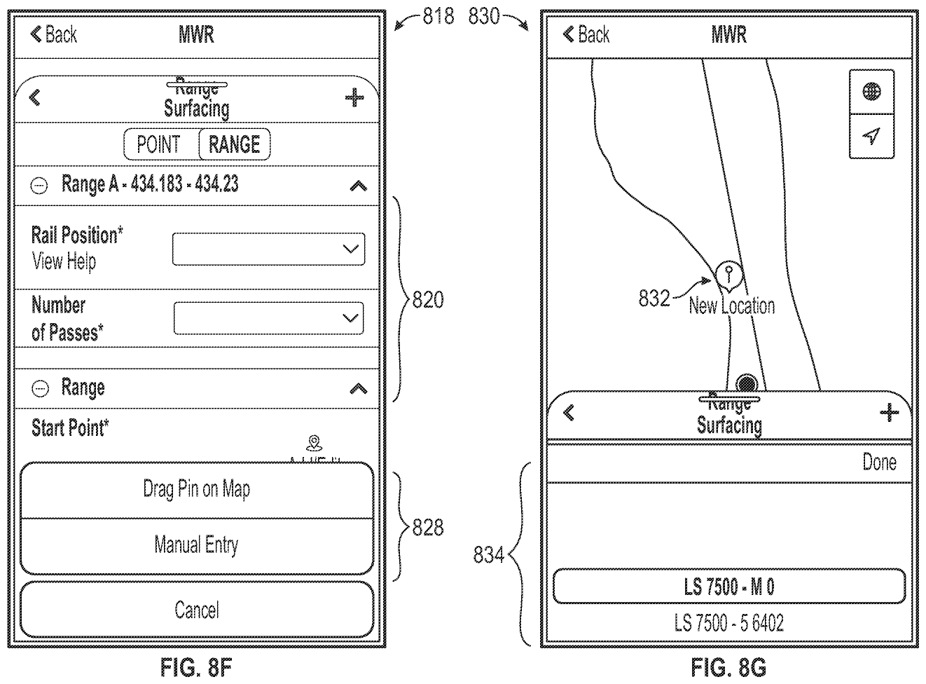

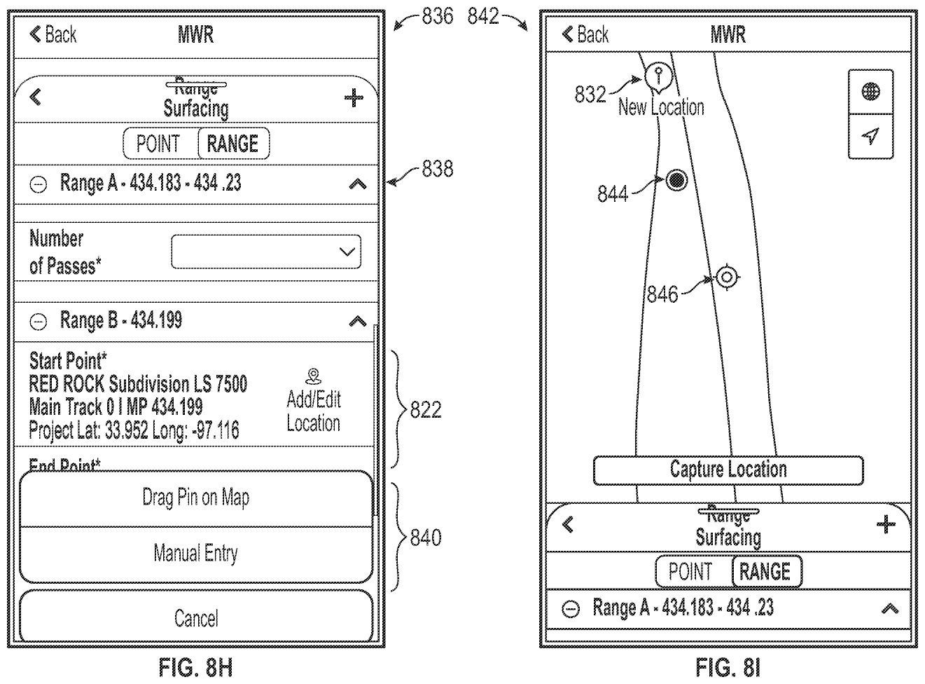

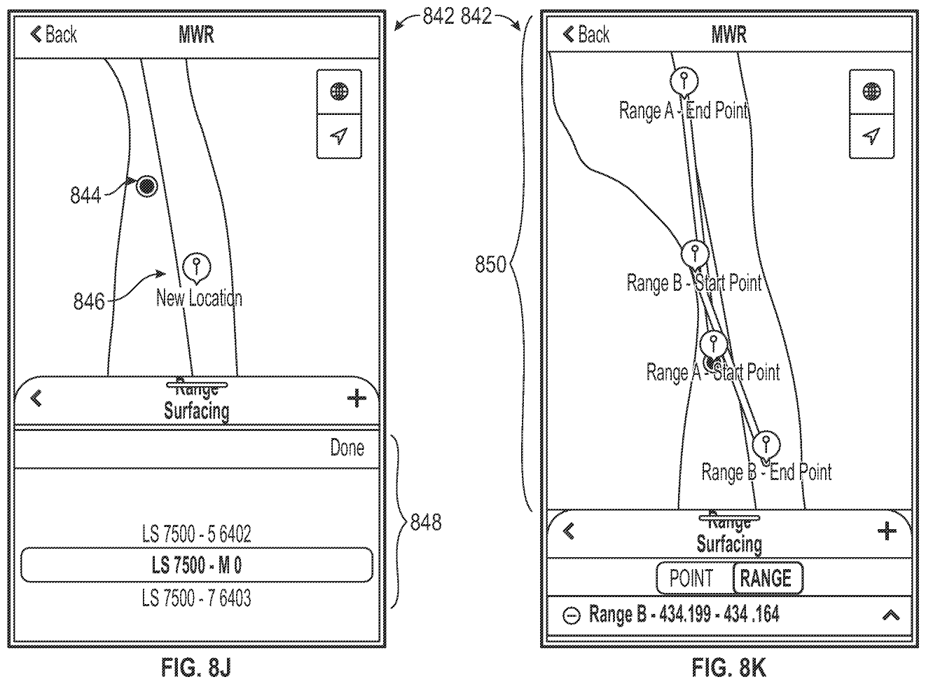

FIGS. 8A-8K illustrate an MWR range interface, in accordance with one or more exemplary embodiments of the present disclosure. Referring to FIG. 8A, a range surfacing screen 800 can include a first range input field 802, a first edit location button 804, a second edit location button 806, and a toggle button 808. The first range input field 802 can include a start point and an end point of the first range. For example, the start point of the first range can include a current location of the client device. The end point of the first range can correspond to the second edit location button 806. The toggle button 808 can correspond to whether a location is taken as a point location or a range of a plurality of locations. Referring to FIG. 8B, the range surfacing screen 800 can further include an edit location prompt 810. The edit location prompt 810 can query a user to input an edited location using either a drag pin method or a manual entry method. Referring to FIG. 8C, an interactive map screen 812 including at least one geographic point 814. Referring to FIG. 8D, the interactive map screen 812 can further include a location verification display 816 to further identify a precise position of the at least one geographic point 814. Referring to FIG. 8E, an updated range surfacing screen 818 can include an updated first range input field 820, a second range input field 822, a third edit location button 824 and a fourth edit location button 826. Referring to FIG. 8F, the updated range surfacing screen 818 can further include an edit location prompt 828. The edit location prompt 828 can query a user to input an edited location using either a drag pin method or a manual entry method. Referring to FIG. 8G, an interactive map screen 830 including at least one geographic point 832. The interactive map screen 830 can further include a location verification display 834 to further identify a precise position of the at least one geographic point 834. Referring to FIG. 8H, a further updated range surfacing screen 836 can include a first range value 838, the second range input field 822, and an edit location prompt 840. The edit location prompt 840 can query a user to input an edited location using either a drag pin method or a manual entry method. Referring to FIG. 8I, an interactive map screen 842 including at least one geographic point 832, 844, and 846. Referring to FIG. 8J, the interactive map screen 842 can further include a location verification display 848 to further identify a precise position of the at least one geographic point 832, 844, and 846. Referring to FIG. 8K, the interactive map screen 842 can display an overlap of ranges 850. For example, the overlap of ranges can include the first range and the second range.

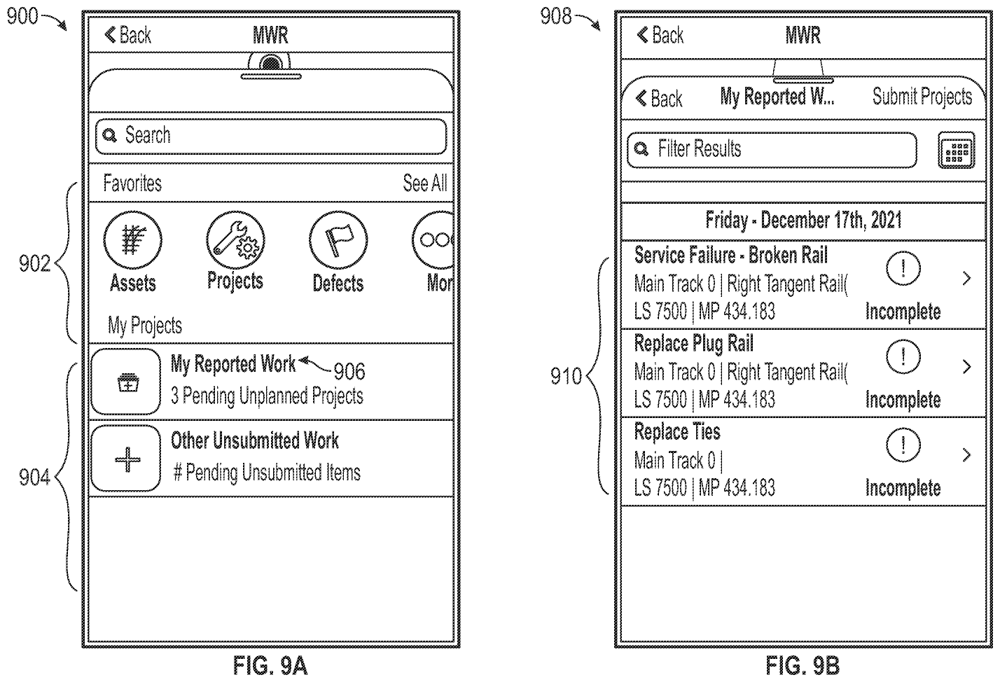

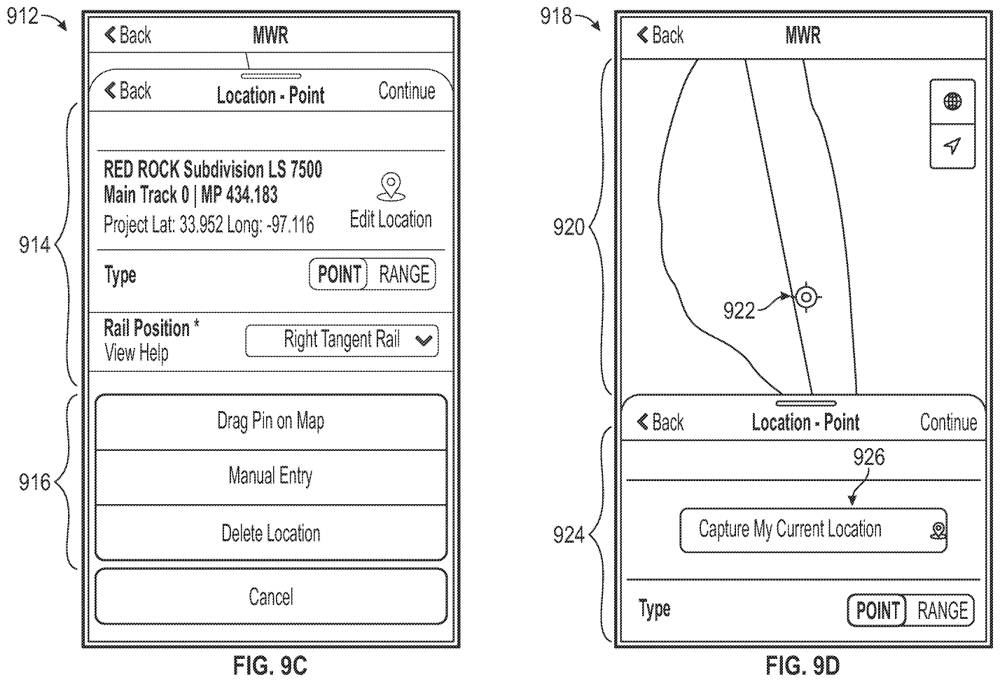

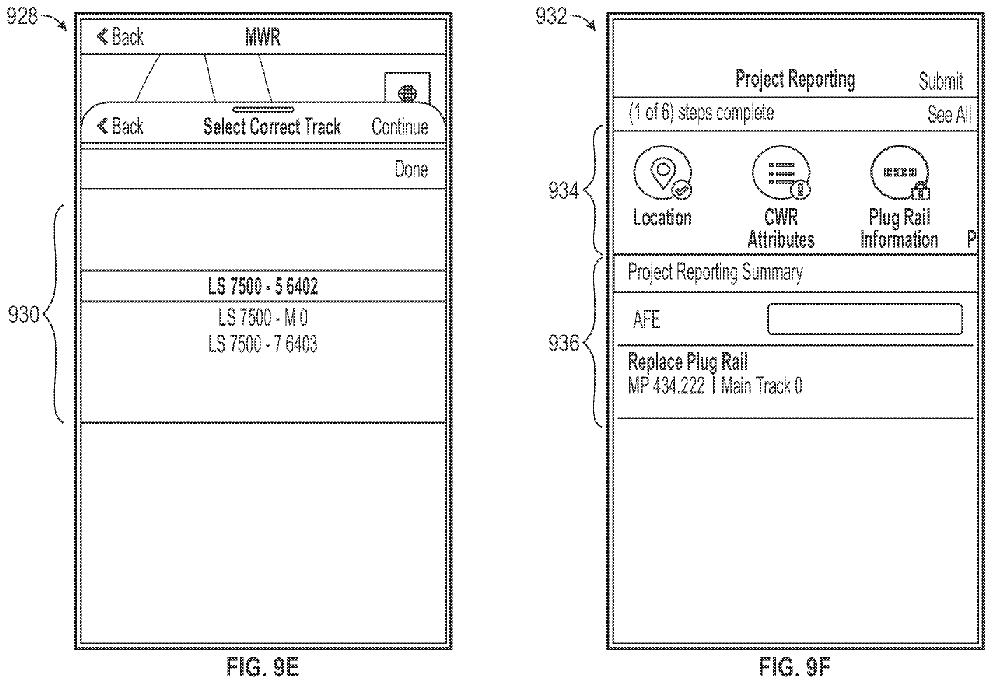

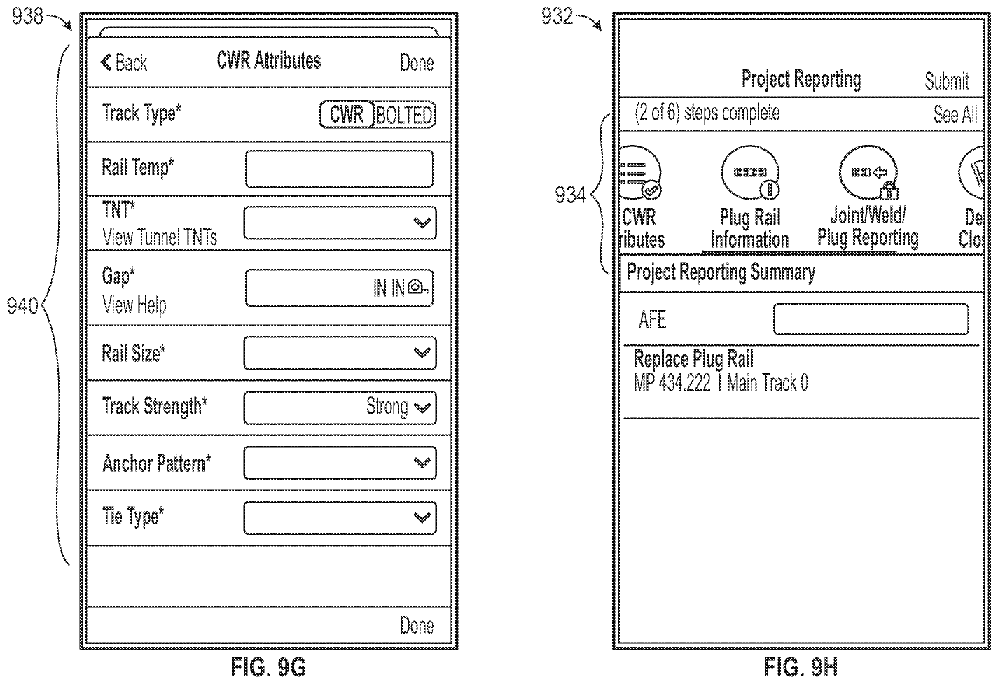

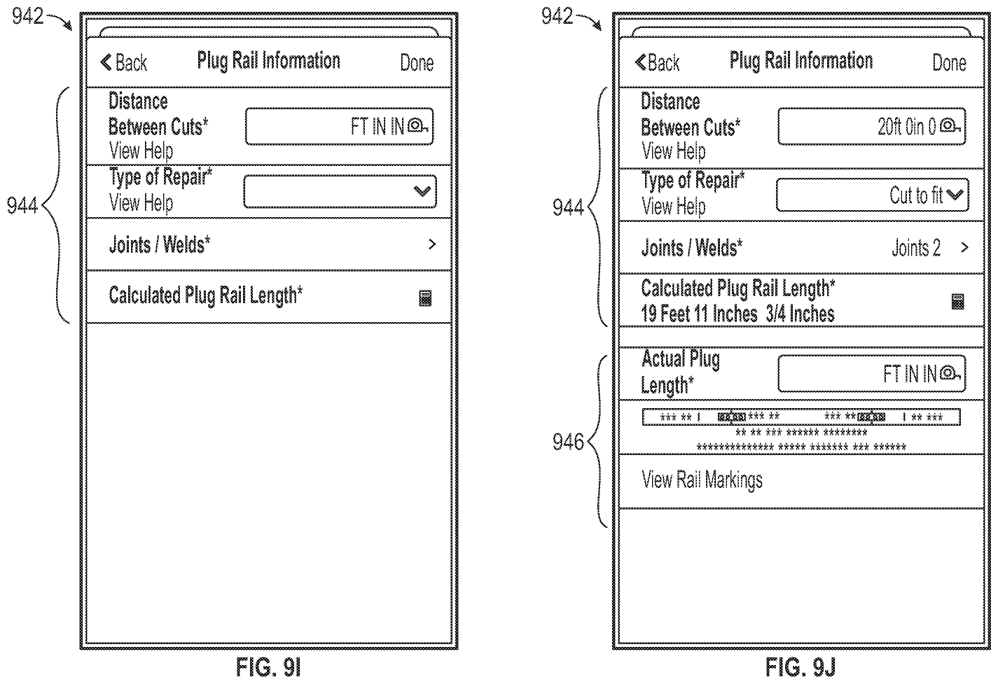

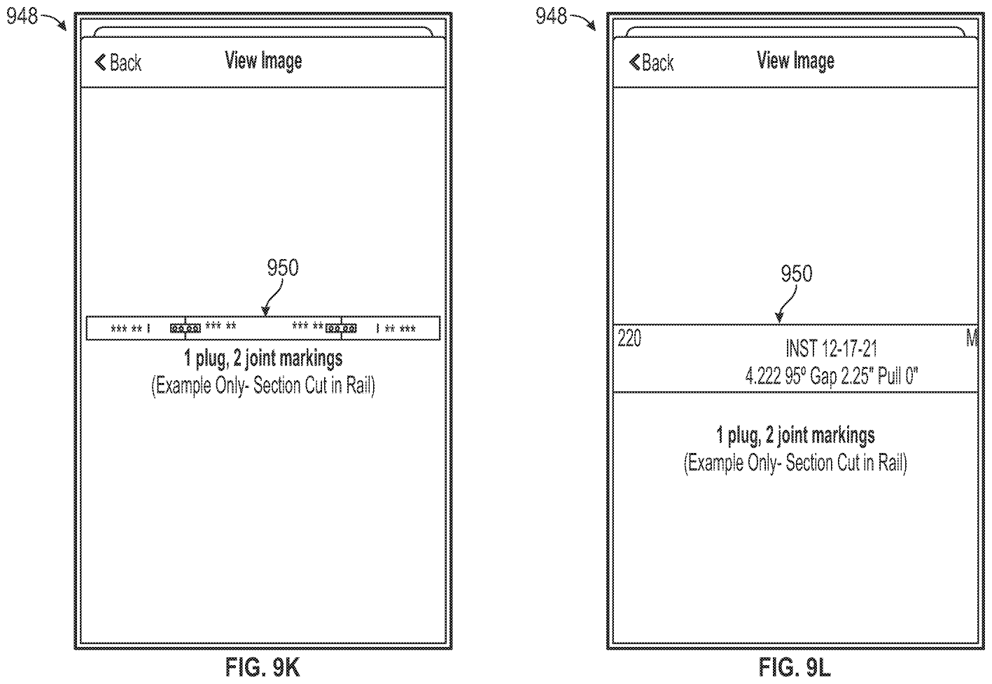

FIGS. 9A-9L illustrate an MWR projects interface, in accordance with one or more exemplary embodiments of the present disclosure. Referring to FIG. 9A, a projects screen 900 can include project types 902 and a My Projects section 904. The project types 902 can include assets, projects, defects, and other project types. The My Projects section 904 can include a My Reported Work button 906. Referring to FIG. 9B, a My Reported Work screen 908 can include at least one project 910. Alternatively, the My Reported Work screen 908 can include no projects. In an example, the at least one project 910 can include information such as a project description, a status of the project, and a location. Referring to FIG. 9C, a reported project screen 912 can include project information 914 and an edit location prompt 916. Referring to FIG. 9D, an interactive map screen 918 including at least one geographic point 922. The interactive map screen 918 can further include a capture location button 924. Referring to FIG. 9E, a select correct track screen 928 can include track markers 930, where the track markers 930 correspond to proximate track markers to the current location. Referring to FIG. 9F, a project reporting screen 932 can include process steps 934 and a project reporting summary 936. Referring to FIG. 9G, a continuous welded rail (CWR) screen 938 can include CWR attributes 940. The CWR attributes 940 can include a track type, a rail temperature, a track neutral temperature (TNT), gap, rail size, track strength, anchor pattern, and tie pattern, among other CWR attributes. Referring to FIG. 9H, the project reporting screen 934 can include updated icons indicating a progress of the project reporting. Referring to FIG. 9I, a plug rail information screen 942 can include plug rail information 944. The plug rail information 944 can include distance between cuts, type of repair, joint/welds, and a calculated plug rail length, among other plug rail information. Referring to FIG. 9J, the plug rail information screen 942 can display a project information 946. Referring to FIG. 9K, a view image screen 948 can include a digital representation 950. The digital representation 950 can include a recommendation about the visual aspects of the work to be completed. For example, if the work to be completed is a joint, the digital representation 950 can visualize the joint on a railway. Referring to FIG. 9L, the view image screen 948 can further illustrate the digital representation 950 including a digital signature of a field user who completed the work and other relevant information associated to the project.

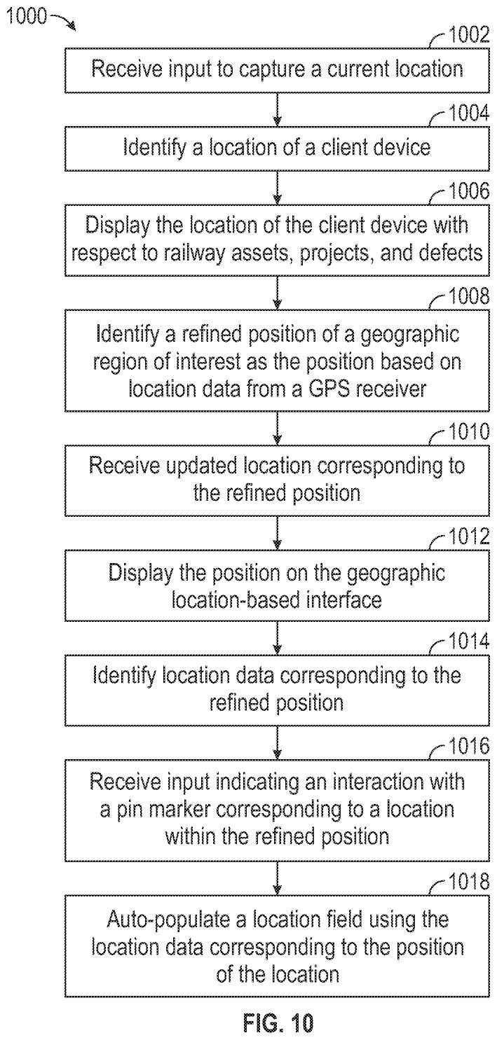

FIG. 10 illustrates a flowchart exemplifying MWR control logic 1000, in accordance with at least one embodiment of the present disclosure. The MWR control logic 1000 can be implemented as an algorithm on a computer processor (e.g., vital logic controller, microprocessor, FPGA, ASIC, server, etc.), a machine learning module, or other suitable system. Additionally, the MWR control logic 1000 can be achieved with software, hardware, firmware, an API, a network connection, a network transfer protocol, HTML, DHTML, JavaScript, Dojo, Ruby, Rails, other suitable applications, or a suitable combination thereof.

In an embodiment, the MWR control logic 1000 can interface with a memory for storing information about railway assets, defects, and projects in a plurality of network-based non-transitory storage devices having the collection of railway information thereon. Additionally, the MWR control logic 1000 can interface the memory with a networked computer processor operably coupled to the memory and capable of executing machine-readable instructions to perform program steps. The MWR control logic 1000 implementing hardware components (e.g., computer processor) can be capable of executing machine-readable instructions to perform program steps and operably coupled to a memory for storing the information about the railway assets, defects, and projects.

The MWR control logic 1000 can leverage the ability of a computer platform to spawn multiple processes and threads by processing data simultaneously. The speed and efficiency of the MWR control logic 1000 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1000 can also be distributed amongst a plurality of networked computer processors. The MWR control logic 1000 of the present embodiment begins at step 1002.

At step 1002, in an embodiment, the control logic 1000 can receive an input to capture a current location of a client device (e.g., client device 175 in FIGS. 1 and 2). For example, the control logic 1000 can capture the current location of the client device based on information from wireless communication signals between the client device and a wireless network. In an example, the information can include location data corresponding to the current location of the client device. The location data can include latitude and longitude coordinates, GPS data, line sight markers, milepost marker information, or another sort of location data corresponding to the current location.

In another example, the control logic 1000 can perform mathematical operations for estimating a position of the client device. The mathematical operations for estimating the position can include trilateration of the position based on location data received by the control logic 1000. For example, the location data can include information corresponding to a satellite constellation over the geographic location of the user. The control logic 1000 can use the location data to estimate the position of the client device based on known reference location information. The known reference information can correspond to a locally stored reference position or calculated from a lag time of the time of flight for the location data. In an example, the control logic 1000 can coordinate the location data to a known pseudo-random code to identify a distance from the GPS constellation. In another example, the control logic 1000 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data.

In another example, the control logic 1000 can provide a capture location input icon. In an example, the control logic 1000 can identify whether the user selects to provide the location of the user based on an interaction between the user and the control logic 1000. In an example, the control logic 1000 can receive an input from the user selecting the capture location input icon. The input from the user enables the control logic 1000 to capture the location of the client device. The control logic 1000 then proceeds to step 1004.

At step 1004, in an embodiment, the control logic 1000 can identify a location of a client device used by the user based on location data from a GPS receiver. For example, the control logic 1000 can receive the location data including geo-coded information corresponding to the current location of the client device. For example, the geo-coded information can include a communication packet generated such that the components of the packet include location-based information corresponding to the current location. In an example, the geo-coded information can correspond to a segment of track proximate to the client device. In another example, the control logic 1000 can receive the geo-coded information from a satellite constellation, a network-based server, a wireless communications tower, or from another form of wireless communication. In an example, the communication packet can include a location-based identifier as a header of the packet. In another example, the geo-coded information can include location identifying information such as the latitude and longitude of the current location. In an example, the control logic 1000 can receive information from the location data indicating the location of the user. The location data can include various location identifier such as geographic triangulation based on network architecture hardware. For example, the location data can correspond to communications between the client device and a wireless network. In another example, the control logic 1000 can receive location data from GPS hardware corresponding to the client device. For example, the control logic 1000 can receive the location data from an external GPS or a GPS receiver internal to the client device. The control logic 1000 then proceeds to step 1006.

At step 1006, in an embodiment, the control logic 1000 can display the location of the client device with respect to railway assets, defects, and projects. For example, the control logic 1000 can display at least one of the railway assets, defects, and projects as icons along a geographic location-based interface. In an example, the control logic 1000 can receive location data corresponding to the current location. In an example, the control logic 1000 can receive the location data from a satellite constellation. The location data can identify the current location and proximate locations to the current location. For example, the location data can identify the segment of track and track marker identifiers along the segment of track. The control logic 1000 can transmit the refined location. The control logic 1000 then proceeds to step 1008.

At step 1008, in an embodiment, the control logic 1000 can identify the refined position of the client device based on location data from a GPS receiver and the pin marker identifying the refined position. In an example, the control logic 1000 can receive input from the user to modify the current location. For example, the control logic 1000 can identify the refined position based on known location parameters from the GPS receiver. In an example, the control logic 1000 can reference the position of the pin marker on the geographic location-based interface with physical locations proximate to the position of the client device. For example, the control logic 1000 can interface with the GPS receiver such that the GPS receiver provides location data of the physical locations proximate to the client device. The control logic 1000 can transmit the refined position of the client device. In this manner, the control logic 1000 can receive the input from the user in the form of the user interacting with the location-based interface by touching and sliding the pin marker to a refined location. The control logic 1000 can identify the refined location based on the location data. The control logic 1000 then proceeds to step 1010.

At step 1010, in an embodiment, the control logic 1000 can receive updated locations corresponding to the refined position. For example, the control logic 1000 can query an external network-based server for proximate locations of the railway assets, defects, and projects within a predetermined distance away from the refined location. In an example, the control logic 1000 can query the server using location data from the GPS receiver. For example, the control logic 1000 can receive location data corresponding to the location of the client device. The location of the client device can correspond to a pin marker displayed as part of a geographic location-based interface on the client device. The control logic 1000 can receive the query including the location of the client device. The control logic 1000 can identify the location of the client device and organize the locations based on a proximity of the locations to the location of the client device. For example, the control logic 1000 can refine search results of the locations based on a proximity threshold. The proximity threshold can include a distance value away from the location of the client device considered relevant to the location of the client device. In an example, the refined location can be constrained by a physical display of the client device in response to an input by the user.

In another example, the control logic 1000 can receive the locations from the network-based server including the proximate locations to the refined location. The control logic 1000 can receive the locations in the form of at least one data packet from the network-based server. The at least one data packet can correspond to a structure to transmit the locations to the client device. The control logic 1000 can generate relative positions from the pin marker to the locations to display the locations in order of proximity to the refined location. The control logic 1000 can identify the refined location based on the location data. The control logic 1000 then proceeds to step 1012.

At step 1012, in an embodiment, the control logic 1000 can display the new position on the geographic location-based interface. For example, the control logic 1000 can provide a digital representation of the geographic location-based interface on the client device. In an example, the control logic 1000 can display the new position in reference to the current location. The control logic 1000 then proceeds to step 1014.

At step 1014, in an embodiment, the control logic 1000 can identify location data corresponding to the new position of the client device. For example, the control logic 1000 can reference the new position to proximate locations to the client device. In this manner, the control logic 1000 can provide corresponding location data to another location input parameter using the GUI. For example, the control logic 1000 can store the location data in local memory such that the control logic 1000 can reference the location data when necessary. In an example, the control logic 1000 can reference the location data when completing another location input using the GUI. The control logic 1000 then proceeds to step 1016.

At step 1016, in an embodiment, the control logic 1000 can receive an input to select a refined position of the client device on the interface. For example, the control logic 1000 can receive the input indicating the user is to drag the pin marker to the new location on the geographic location-based interface. The control logic 1000 then proceeds to step 1018.

At step 1018, in an embodiment, the control logic 1000 can auto-populate a location field using the location data corresponding to the position of the client device. For example, the control logic 1000 can reference the location data from local memory to populate another location input. In an example, the control logic 1000 can populate the location data in a location field for a new railway asset, defect, or project when the client device is at a same location as identified using the location data.

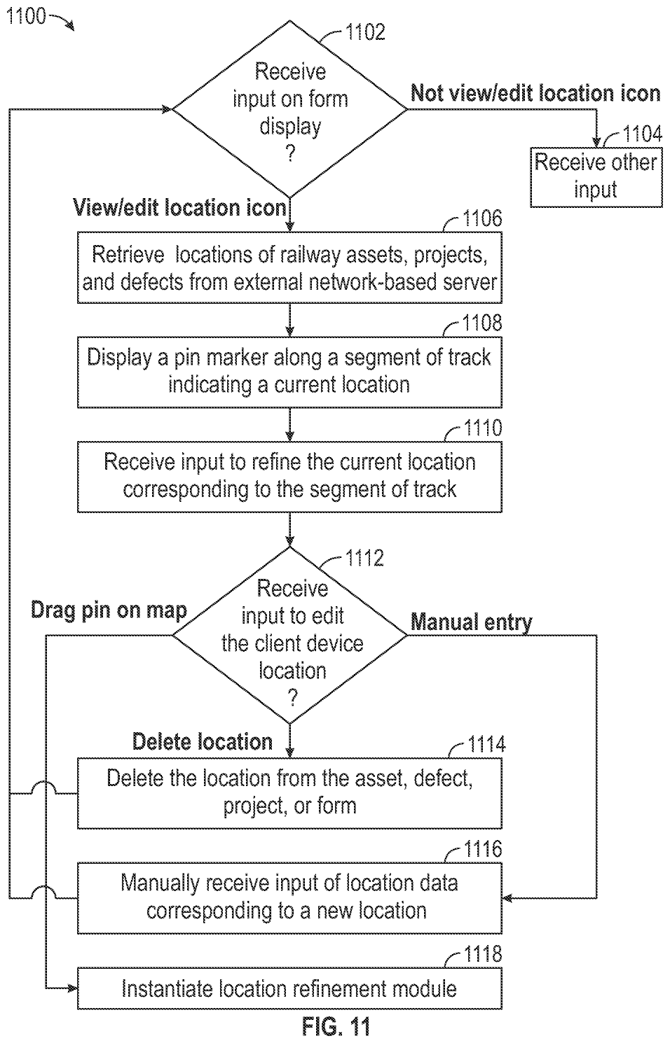

FIG. 11 illustrates a flowchart exemplifying MWR control logic 1100, in accordance with at least one embodiment of the present disclosure. The MWR control logic 1100 can be implemented as an algorithm on a computer processor (e.g., vital logic controller, microprocessor, FPGA, ASIC, server, etc.), a machine learning module, or other suitable system. Additionally, the MWR control logic 1100 can be achieved with software, hardware, firmware, an API, a network connection, a network transfer protocol, HTML, DHTML, JavaScript, Dojo, Ruby, Rails, other suitable applications, or a suitable combination thereof.

In an embodiment, the MWR control logic 1100 can interface with a memory for storing information about railway assets, defects, and projects in a plurality of network-based non-transitory storage devices having the collection of railway information thereon. Additionally, the MWR control logic 1100 can interface the memory with a networked computer processor operably coupled to the memory and capable of executing machine-readable instructions to perform program steps. The MWR control logic 1100 implementing hardware components (e.g., computer processor) can be capable of executing machine-readable instructions to perform program steps and operably coupled to a memory for storing the information about the railway assets, defects, and projects.

The MWR control logic 1100 can leverage the ability of a computer platform to spawn multiple processes and threads by processing data simultaneously. The speed and efficiency of the MWR control logic 1100 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1100 can also be distributed amongst a plurality of networked computer processors. The MWR control logic 1100 of the present embodiment begins at step 1102.

At step 1102, in an embodiment, the control logic 1100 can determine whether a user interacts with a view/edit location icon. For example, the control logic 1100 can provide the user an interface to identify a location of the user. The location icon can correspond to a plurality of bits (e.g., based on a digitizer of the display 146 in FIG. 2). In an example, when the user interacts with the location icon, the bit value corresponding to the location icon can be at least one binary value. If the control logic 1100 determines the user interacts with the view/edit location icon, the control logic 1100 then proceeds to step 1106. If the control logic 1100 determines the user does not interact with the view/edit location icon, the control logic 1100 then proceeds to step 1104.

At step 1104, in an embodiment, the control logic 1100 can receive another input by the user. For example, the control logic 1100 can provide a plurality of icons. In an example, the control logic 1100 can receive inputs to at least one of the plurality of icons, where the view/edit location icon is not one of the plurality of icons.

At step 1106, in an embodiment, the control logic 1100 can receive an input to capture locations of at least one of railway assets, defects, and projects. For example, the control logic 1100 can capture the locations based on information from wireless communication signals between the client device and a wireless network. In an example, the information can include location data corresponding to a current location of the client device. The location data can include latitude and longitude coordinates, GPS data, line sight markers, milepost marker information, or another sort of location data corresponding to the current location.

In another example, the control logic 1100 can perform mathematical operations for estimating a position of the locations with respect to the client device. The mathematical operations for estimating the position can include trilateration of the position based on location data received by the control logic 1100. For example, the location data can include information corresponding to a satellite constellation over the geographic location of the user. The control logic 1100 can use the location data to estimate the position of the client device based on known reference location information. The known reference information can correspond to a locally stored reference position or calculated from a lag time of the time of flight for the location data. In an example, the control logic 1100 can coordinate the location data to a known pseudo-random code to identify a distance from the GPS constellation. In another example, the control logic 1100 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data. The control logic 1100 then proceeds to step 1108.

At step 1108, in an embodiment, the control logic 1100 can display a pin marker along a segment of track indicating a current location. For example, the control logic 1100 can display a plurality of closest track markers to the current location of the client device. In an example, the control logic 1100 can transmit the current location of the client device to an external network-based server to query the server for closest track markers to the current location. For example, the control logic 1100 can receive the closest track markers from the server and display the queries. The display of the queries can include an interactive icon-based scroll menu including the closest track markers. In an example, the closest track markers can include a line segment value and a milepost marker value. For example, the closes track markers can include a line segment value of “LS 7500” and a milepost marker of “5.6402.” The control logic 1100 then proceeds to step 1110.

At step 1110, in an embodiment, the control logic 1100 can receive input to refine the current location corresponding to the segment of track. For example, the control logic 1100 can identify the selection of the user based on the input. The input can correspond to one of the closest track markers. In this manner, the control logic 1100 can best approximate the current location of the client device with a reference frame to the closest track markers. The control logic 1100 then proceeds to step 1112.

At step 1112, in an embodiment, the control logic 1100 can determine whether the user interacts with an edit location icon. The control logic 1100 can provide the user with a plurality of options in response to receiving an interaction on the edit location icon. For example, the control logic 1100 can provide the user options to delete the current location, enter a new location manually, and enter a new location by dragging a pin on a map. In an example, the map is the geographic location-based interface on the display 146. For example, the control logic 1100 can provide the user an interface to identify whether the user requests to edit the current location. The edit location icon can correspond to a plurality of bits (e.g., based on a digitizer of the display 146 of FIG. 2). In an example, when the user interacts with the edit location icon, the bit value corresponding to the edit location icon can be at least one binary value. In an example, the control logic 1100 can correspond subsequent interactions with the user to at least one bit indicating a selection by the user in response to the options. If the control logic 1100 determines the user interacts with the edit location icon and the delete location option, the control logic 1100 then proceeds to step 1114. If the control logic 1100 determines the user interacts with the edit location icon and the manual entry option, the control logic 1100 then proceeds to step 1116. If the control logic 1100 determines the user interacts with the edit location icon and the pin drag option, the control logic 1100 then proceeds to step 1118.

At step 1114, in an embodiment, the control logic 1100 can delete the location of the railway asset, defect, or project. For example, the control logic 1100 can remove the current location from local memory of the client device. In this manner, the control logic 1100 can query the user for another input corresponding to the current location of the client device. The query from the control logic 1100 can correspond to a project for the railway asset, defect, or project or a new project entirely. The control logic 1100 then proceeds to step 1102.

At step 1116, in an embodiment, the control logic 1100 can manually receive input of location data corresponding to the location of the user. For example, the control logic 1100 can receive an input from the user indicating location data manually entered. In an example, the control logic 1100 can receive the location data in the form of latitude and longitude coordinates, GPS data, line segment markers, milepost markers, or another form of location identifier for the current location of the client device. The control logic 1100 then proceeds to step 1102.

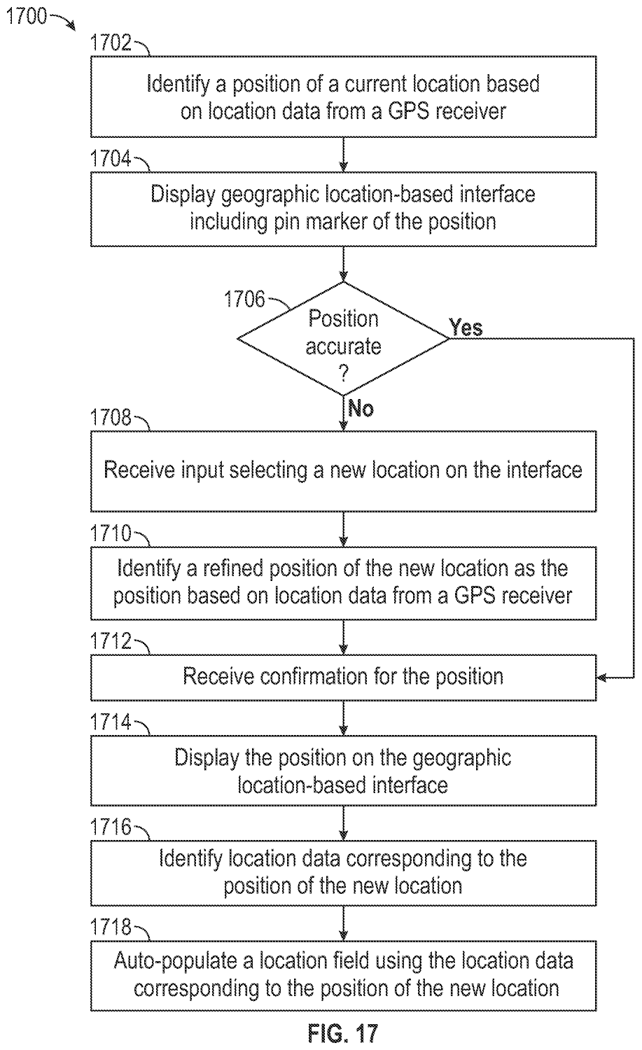

At step 1118, in an embodiment, the control logic 1100 can instantiate a location refinement module. For example, the location refinement module can incorporate the processes described below in FIG. 17.

FIG. 12 illustrates a flowchart exemplifying MWR control logic 1200, in accordance with at least one embodiment of the present disclosure. The MWR control logic 1200 can be implemented as an algorithm on a computer processor (e.g., vital logic controller, microprocessor, FPGA, ASIC, server, etc.), a machine learning module, or other suitable system. Additionally, the MWR control logic 1200 can be achieved with software, hardware, firmware, an API, a network connection, a network transfer protocol, HTML, DHTML, JavaScript, Dojo, Ruby, Rails, other suitable applications, or a suitable combination thereof. The MWR control logic 1200 can interface electrical components to control mechanical components using logic processors.

In an embodiment, the MWR control logic 1200 can interface with a memory for storing information about railway assets, defects, and projects in a plurality of network-based non-transitory storage devices having the collection of railway information thereon. Additionally, the MWR control logic 1200 can interface the memory with a networked computer processor operably coupled to the memory and capable of executing machine-readable instructions to perform program steps. The MWR control logic 1200 implementing hardware components (e.g., computer processor) can be capable of executing machine-readable instructions to perform program steps and operably coupled to a memory for storing the information about the railway assets, defects, and projects.

The MWR control logic 1200 can leverage the ability of a computer platform to spawn multiple processes and threads by processing data simultaneously. The speed and efficiency of the MWR control logic 1200 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1200 can also be distributed amongst a plurality of networked computer processors. The MWR control logic 1200 of the present embodiment begins at step 1202.

At step 1202, in an embodiment, the control logic 1200 can determine whether a user interacts with an assets icon. For example, the control logic 1200 can provide the user an interface to identify a location of the user to complete an update associated to at least one of railway assets, defects, and projects. The location icon can correspond to a plurality of bits (e.g., based on a digitizer of the display 146 in FIG. 2). In an example, when the user interacts with the location icon, the bit value corresponding to the location icon can be at least one binary value. If the control logic 1200 determines the user interacts with the location icon, the control logic 1200 then proceeds to step 1206. If the control logic 1200 determines the user does not interact with the location icon, the control logic 1200 then proceeds to step 1204.

At step 1204, in an embodiment, the control logic 1200 can receive another input by the user. For example, the control logic 1200 can provide a plurality of icons. In an example, the control logic 1200 can receive inputs to at least one of the plurality of icons, where the assets icon is not one of the plurality of icons.

At step 1206, in an embodiment, the control logic 1200 can retrieve locations of railway assets from external network-based server. For example, the control logic 1200 can query a network-based server for location data corresponding to the railway assets. The location data can include latitude and longitude coordinates, GPS data, line sight markers, milepost marker information, or another sort of location data corresponding to the current location. In an example, the control logic 1200 can capture the current location of the client device based on information from wireless communication signals between the client device and a wireless network. The information can include location data corresponding to the current location of the client device.

In another example, the control logic 1200 can perform mathematical operations for estimating a position of the client device. The mathematical operations for estimating the position can include trilateration of the position based on location data received by the control logic 1200. For example, the location data can include information corresponding to a satellite constellation over the geographic location of the user. The control logic 1200 can use the location data to estimate the position of the client device based on known reference location information. The known reference information can correspond to a locally stored reference position or calculated from a lag time of the time of flight for the location data. In an example, the control logic 1200 can coordinate the location data to a known pseudo-random code to identify a distance from the GPS constellation. In another example, the control logic 1200 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data. The control logic 1200 then proceeds to step 1208.

At step 1208, in an embodiment, the control logic 1200 can display a pin marker along a segment of track indicating a current location. For example, the track correction input field can display a plurality of closest track markers to the current location of the client device. In an example, the control logic 1200 can transmit the current location of the client device to an external network-based server to query the server for closest track markers to the current location. For example, the control logic 1200 can receive the closest track markers from the server and display the queries. The display of the queries can include an interactive icon-based scroll menu including the closest track markers. In an example, the closest track markers can include a line segment value and a milepost marker value. For example, the closes track markers can include a line segment value of “LS 7500” and a milepost marker of “5.6402.” The control logic 1200 then proceeds to step 1210.

At step 1210, in an embodiment, the control logic 1200 can filter results of the railway assets sorted by proximity to a client device location. For example, the control logic 1200 can reference the railway asset to proximate locations to the client device. In this manner, the control logic 1200 can provide corresponding location data to another location input parameter using the GUI. For example, the control logic 1200 can store the location data in local memory such that the control logic 1200 can reference the location data when necessary. In an example, the control logic 1200 can reference the location data when completing another location input using the GUI. The control logic 1200 then proceeds to step 1212.

At step 1212, in an embodiment, the control logic 1200 can determine whether the asset is available using the GUI. For example, the control logic 1200 can display a list of available assets in the GUI. The control logic 1200 can determine whether the asset is available in response to receiving an input from the user. For example, when the control logic 1200 receives the input from the user, indicating the asset is available. If the asset is available, the control logic 1200 then proceeds to step 1214. If the asset is not available, the control logic 1200 then proceeds to step 1216.

At step 1214, in an embodiment, the control logic 1200 can select one of the railway assets from the GUI display. For example, the control logic 1200 can display a list of available assets in the GUI. In an example, the control logic 1200 can receive an input from the user indicating a selection of the asset. In an example, the control logic 1200 can sense the input from the user based on an interaction on the screen of the client device.

At step 1216, in an embodiment, the control logic 1200 can receive input to perform an advanced search based on additional information about an asset. For example, the control logic 1200 can include an updated list of defects and an advanced search function allowing a user to search a database of defects using granular information. The advanced search function can include a plurality of advanced search input fields. The plurality of advanced search input fields can include line segment, track type, track number, beginning mile post marker, end mile post marker, among other relevant search characteristics. The control logic 1200 then proceeds to step 1218.

At step 1218, in an embodiment, the control logic 1200 can search the server using the additional information to find the asset. For example, the control logic 1200 can query the server applying the additional information. The control logic 1200 can cross-reference results from the server with the additional information to identify a closest match to the advanced search function. In an example, the control logic 1200 can interface with the server to receive the closest match to the additional information.

FIG. 13 illustrates a flowchart exemplifying MWR control logic 1300, in accordance with at least one embodiment of the present disclosure. The MWR control logic 1300 can be implemented as an algorithm on a computer processor (e.g., vital logic controller, microprocessor, FPGA, ASIC, server, etc.), a machine learning module, or other suitable system. Additionally, the MWR control logic 1300 can be achieved with software, hardware, firmware, an API, a network connection, a network transfer protocol, HTML, DHTML, JavaScript, Dojo, Ruby, Rails, other suitable applications, or a suitable combination thereof.

In an embodiment, the MWR control logic 1300 can interface with a memory for storing information about railway assets, defects, and projects in a plurality of network-based non-transitory storage devices having the collection of railway information thereon. Additionally, the MWR control logic 1300 can interface the memory with a networked computer processor operably coupled to the memory and capable of executing machine-readable instructions to perform program steps. The MWR control logic 1300 implementing hardware components (e.g., computer processor) can be capable of executing machine-readable instructions to perform program steps and operably coupled to a memory for storing the information about the railway assets, defects, and projects.

The MWR control logic 1300 can leverage the ability of a computer platform to spawn multiple processes and threads by processing data simultaneously. The speed and efficiency of the MWR control logic 1300 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1300 can also be distributed amongst a plurality of networked computer processors. The MWR control logic 1300 of the present embodiment begins at step 1302.

At step 1302, in an embodiment, the control logic 1300 can determine whether a user interacts with a projects icon. For example, the control logic 1300 can provide the user an interface to identify a project of the user. The projects icon can correspond to a plurality of bits (e.g., based on a digitizer of the display 146 in FIG. 2). In an example, when the user interacts with the projects icon, the bit value corresponding to the projects icon can be at least one binary value. If the control logic 1300 determines the user interacts with the projects icon, the control logic 1300 then proceeds to step 1306. If the control logic 1300 determines the user does not interact with the projects icon, the control logic 1300 then proceeds to step 1304.

At step 1304, in an embodiment, the control logic 1300 can receive another input by the user. For example, the control logic 1300 can provide a plurality of icons. In an example, the control logic 1300 can receive inputs to at least one of the plurality of icons, where the projects icon is not one of the plurality of icons.

At step 1306, in an embodiment, the control logic 1300 can receive an input to capture a location of a project. For example, the control logic 1300 can capture the location of the project based on information from wireless communication signals between a client device and a wireless network. In an example, the information can include location data corresponding to the location of the project. The location data can include latitude and longitude coordinates, GPS data, line sight markers, milepost marker information, or another sort of location data corresponding to the location.

In another example, the control logic 1300 can perform mathematical operations for estimating a position of the client device. The mathematical operations for estimating the position can include trilateration of the position based on location data received by the control logic 1300. For example, the location data can include information corresponding to a satellite constellation over the geographic location of the user. The control logic 1300 can use the location data to estimate the position of the client device based on known reference location information. The known reference information can correspond to a locally stored reference position or calculated from a lag time of the time of flight for the location data. In an example, the control logic 1300 can coordinate the location data to a known pseudo-random code to identify a distance from the GPS constellation. In another example, the control logic 1300 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data. The control logic 1300 then proceeds to step 1308.

At step 1308, in an embodiment, the control logic 1300 can determine whether the user indicates a new project. For example, the control logic 1300 can display at least one project in progress for the user. Alternatively, the control logic 1300 can display no projects for the user. If the user indicates to begin the new project, the control logic 1300 then proceeds to step 1310. If the user indicates to not begin the new project, the control logic 1300 then proceeds to step 1312.

At step 1310, in an embodiment, the control logic 1300 can select an existing project in progress to continue editing. For example, the control logic 1300 can identify the selection of the user based on the input. The input can correspond to one of the projects in progress. The control logic 1300 then proceeds to step 1318.

At step 1312, in an embodiment, the control logic 1300 can select aspects relevant to the new project. The control logic 1300 can provide the user with a plurality of options in response to receiving an interaction on the new project icon. For example, the control logic 1300 can display the aspects to the user. The control logic 1300 then proceeds to step 1318.

At step 1314, in an embodiment, the control logic 1300 can identify a segment of track corresponding to the new project. For example, the control logic 1300 can remove the current location from local memory of the client device. In this manner, the control logic 1300 can query the user for another input corresponding to the current location of the client device. The query from the control logic 1300 can correspond to the update or a new update. The control logic 1300 then proceeds to step 1302.

At step 1316, in an embodiment, the control logic 1300 can capture a current location of the client device. For example, the control logic 1300 can capture the current location of the client device based on information from wireless communication signals between the client device and a wireless network. In an example, the information can include location data corresponding to the current location of the client device. The location data can include latitude and longitude coordinates, GPS data, line sight markers, milepost marker information, or another sort of location data corresponding to the current location.

In another example, the control logic 1300 can perform mathematical operations for estimating a position of the client device. The mathematical operations for estimating the position can include trilateration of the position based on location data received by the control logic 1300. For example, the location data can include information corresponding to a satellite constellation over the geographic location of the user. The control logic 1300 can use the location data to estimate the position of the client device based on known reference location information. The known reference information can correspond to a locally stored reference position or calculated from a lag time of the time of flight for the location data. In an example, the control logic 1300 can coordinate the location data to a known pseudo-random code to identify a distance from the GPS constellation. In another example, the control logic 1300 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data.

In another example, the control logic 1300 can provide a capture location input icon. In an example, the control logic 1300 can identify whether the user selects to provide the location of the user based on an interaction between the user and the control logic 1300. In an example, the control logic 1300 can receive an input from the user selecting the capture location input icon. The input from the user enables the control logic 1300 to capture the location of the client device. The control logic 1300 then proceeds to step 1318.

At step 1318, in an embodiment, the control logic 1300 can display a pin marker along a segment of track indicating a current location. For example, the control logic 1300 can display a plurality of closest track markers to the current location of the client device. In an example, the control logic 1300 can transmit the current location of the client device to an external network-based server to query the server for closest track markers to the current location. For example, the control logic 1300 can receive the closest track markers from the server and display the queries. The display of the queries can include an interactive icon-based scroll menu including the closest track markers. In an example, the closest track markers can include a line segment value and a milepost marker value. For example, the closes track markers can include a line segment value of “LS 7500” and a milepost marker of “5.6402.” The control logic 1300 then proceeds to step 1320.

At step 1320, in an embodiment, the control logic 1300 can receive input to refine the current location corresponding to the segment of track. For example, the control logic 1300 can identify the selection of the user based on the input. The input can correspond to one of the closest track markers. In this manner, the control logic 1300 can best approximate the current location of the client device with a reference frame to the closest track markers. The control logic 1300 then proceeds to step 1322.

At step 1322, in an embodiment, the control logic 1300 can determine whether the user interacts with an edit location icon. The control logic 1300 can provide the user with a plurality of options in response to receiving an interaction on the edit location icon. For example, the control logic 1300 can provide the user options to delete the current location, enter a new location manually, and enter a new location by dragging a pin on a map. In an example, the map is the geographic location-based interface on the display 146. For example, the control logic 1300 can provide the user an interface to identify whether the user requests to edit the current location. The edit location icon can correspond to a plurality of bits (e.g., based on a digitizer of the display 146 of FIG. 2). In an example, when the user interacts with the edit location icon, the bit value corresponding to the edit location icon can be at least one binary value. In an example, the control logic 1300 can correspond subsequent interactions with the user to at least one bit indicating a selection by the user in response to the options. If the control logic 1300 determines the user interacts with the edit location icon and the delete location option, the control logic 1300 then proceeds to step 1324. If the control logic 1300 determines the user interacts with the edit location icon and the manual entry option, the control logic 1300 then proceeds to step 1326. If the control logic 1300 determines the user interacts with the edit location icon and the pin drag option, the control logic 1300 then proceeds to step 1328.

At step 1324, in an embodiment, the control logic 1300 can delete the location of the railway asset, defect, or project. For example, the control logic 1300 can remove the current location from local memory of the client device. In this manner, the control logic 1300 can query the user for another input corresponding to the current location of the client device. The query from the control logic 1300 can correspond to a project for the railway asset, defect, or project or a new project entirely. The control logic 1300 then proceeds to step 1302.

At step 1326, in an embodiment, the control logic 1300 can manually receive input of location data corresponding to the location of the user. For example, the control logic 1300 can receive an input from the user indicating location data manually entered. In an example, the control logic 1300 can receive the location data in the form of latitude and longitude coordinates, GPS data, line segment markers, milepost markers, or another form of location identifier for the current location of the client device. The control logic 1300 then proceeds to step 1302.

At step 1328, in an embodiment, the control logic 1300 can instantiate a location refinement module. For example, the location refinement module can incorporate the processes described below in FIG. 17.

FIG. 14 illustrates a flowchart exemplifying MWR control logic 1400, in accordance with at least one embodiment of the present disclosure. The MWR control logic 1400 can be implemented as an algorithm on a computer processor (e.g., vital logic controller, microprocessor, FPGA, ASIC, server, etc.), a machine learning module, or other suitable system. Additionally, the MWR control logic 1400 can be achieved with software, hardware, firmware, an API, a network connection, a network transfer protocol, HTML, DHTML, JavaScript, Dojo, Ruby, Rails, other suitable applications, or a suitable combination thereof. The MWR control logic 1400 can interface electrical components to control mechanical components using logic processors.

In an embodiment, the MWR control logic 1400 can interface with a memory for storing information about railway assets, defects, and projects in a plurality of network-based non-transitory storage devices having the collection of railway information thereon. Additionally, the MWR control logic 1400 can interface the memory with a networked computer processor operably coupled to the memory and capable of executing machine-readable instructions to perform program steps. The MWR control logic 1400 implementing hardware components (e.g., computer processor) can be capable of executing machine-readable instructions to perform program steps and operably coupled to a memory for storing the information about the railway assets, defects, and projects.

The MWR control logic 1400 can leverage the ability of a computer platform to spawn multiple processes and threads by processing data simultaneously. The speed and efficiency of the MWR control logic 1400 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1400 can also be distributed amongst a plurality of networked computer processors. The MWR control logic 1400 of the present embodiment begins at step 1402.

At step 1402, in an embodiment, the control logic 1400 can determine whether a user interacts with an assets icon. For example, the control logic 1400 can provide the user an interface to identify a location of the user to complete an update associated to at least one of railway assets, defects, and projects. The location icon can correspond to a plurality of bits (e.g., based on a digitizer of the display 146 in FIG. 2). In an example, when the user interacts with the location icon, the bit value corresponding to the location icon can be at least one binary value. If the control logic 1400 determines the user interacts with the location icon, the control logic 1400 then proceeds to step 1406. If the control logic 1400 determines the user does not interact with the location icon, the control logic 1400 then proceeds to step 1404.

At step 1404, in an embodiment, the control logic 1400 can receive another input by the user. For example, the control logic 1400 can provide a plurality of icons. In an example, the control logic 1400 can receive inputs to at least one of the plurality of icons, where the assets icon is not one of the plurality of icons.

At step 1406, in an embodiment, the control logic 1400 can retrieve locations of railway assets from external network-based server. For example, the control logic 1400 can query a network-based server for location data corresponding to the railway assets. The location data can include latitude and longitude coordinates, GPS data, line sight markers, milepost marker information, or another sort of location data corresponding to the current location. In an example, the control logic 1400 can capture the current location of the client device based on information from wireless communication signals between the client device and a wireless network. The information can include location data corresponding to the current location of the client device.

In another example, the control logic 1400 can perform mathematical operations for estimating a position of the client device. The mathematical operations for estimating the position can include trilateration of the position based on location data received by the control logic 1400. For example, the location data can include information corresponding to a satellite constellation over the geographic location of the user. The control logic 1400 can use the location data to estimate the position of the client device based on known reference location information. The known reference information can correspond to a locally stored reference position or calculated from a lag time of the time of flight for the location data. In an example, the control logic 1400 can coordinate the location data to a known pseudo-random code to identify a distance from the GPS constellation. In another example, the control logic 1400 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data. The control logic 1400 then proceeds to step 1408.

At step 1408, in an embodiment, the control logic 1400 can display a pin marker along a segment of track indicating a current location. For example, the track correction input field can display a plurality of closest track markers to the current location of the client device. In an example, the control logic 1400 can transmit the current location of the client device to an external network-based server to query the server for closest track markers to the current location. For example, the control logic 1400 can receive the closest track markers from the server and display the queries. The display of the queries can include an interactive icon-based scroll menu including the closest track markers. In an example, the closest track markers can include a line segment value and a milepost marker value. For example, the closes track markers can include a line segment value of “LS 7500” and a milepost marker of “5.6402.” The control logic 1400 then proceeds to step 1410.

At step 1410, in an embodiment, the control logic 1400 can filter results of the railway assets sorted by proximity to a client device location. For example, the control logic 1400 can reference the railway asset to proximate locations to the client device. In this manner, the control logic 1400 can provide corresponding location data to another location input parameter using the GUI. For example, the control logic 1400 can store the location data in local memory such that the control logic 1400 can reference the location data when necessary. In an example, the control logic 1400 can reference the location data when completing another location input using the GUI. The control logic 1400 then proceeds to step 1412.

At step 1412, in an embodiment, the control logic 1400 can determine a type of defect. The control logic 1400 then proceeds to step 1414.

At step 1414, in an embodiment, the control logic 1400 can determine whether the asset is available using the GUI. For example, the control logic 1400 can display a list of available assets in the GUI. The control logic 1400 can determine whether the asset is available in response to receiving an input from the user. For example, when the control logic 1400 receives the input from the user, indicating the asset is available. If the defect is available, the control logic 1400 then proceeds to step 1416. If the defect is unavailable, the control logic 1400 then proceeds to step 1418.

At step 1416, in an embodiment, the control logic 1400 can select one of the railway assets from the GUI display. For example, the control logic 1400 can display a list of available defects in the GUI. In an example, the control logic 1400 can receive an input from the user indicating a selection of the asset. In an example, the control logic 1400 can sense the input from the user based on an interaction on the screen of the client device.

At step 1418, in an embodiment, the control logic 1400 can receive input to perform an advanced search based on additional information about a defect. For example, the control logic 1400 can include an updated list of defects and an advanced search function allowing a user to search a database of defects using granular information. The advanced search function can include a plurality of advanced search input fields. The plurality of advanced search input fields can include line segment, track type, track number, beginning mile post marker, end mile post marker, among other relevant search characteristics. The control logic 1400 then proceeds to step 1420.

At step 1420, in an embodiment, the control logic 1400 can search the server using the additional information to find the defect. For example, the control logic 1400 can query the server applying the additional information. The control logic 1400 can cross-reference results from the server with the additional information to identify a closest match to the advanced search function. In an example, the control logic 1400 can interface with the server to receive the closest match to the additional information.

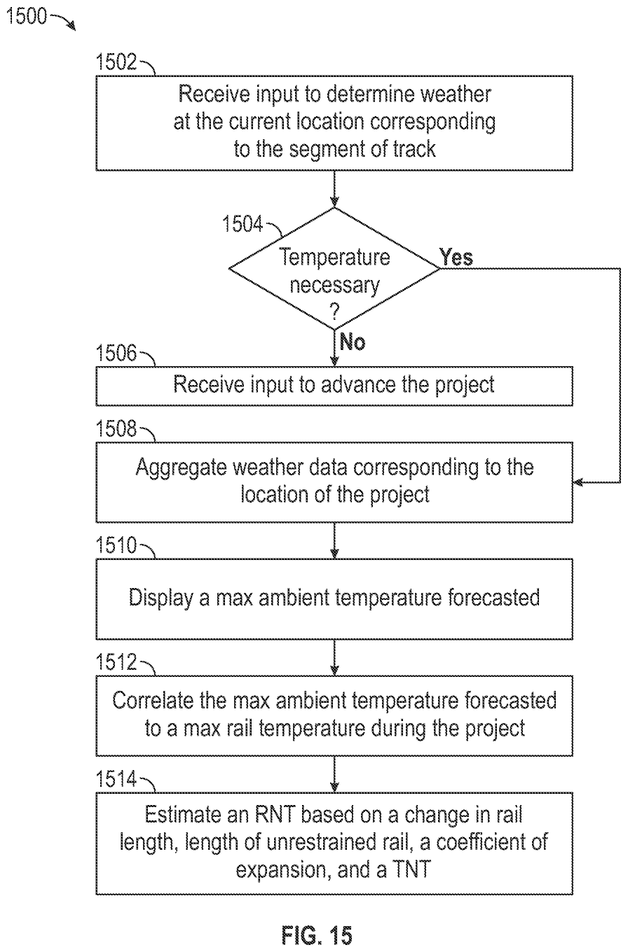

FIG. 15 illustrates a flowchart exemplifying MWR control logic 1500, in accordance with at least one embodiment of the present disclosure. The MWR control logic 1500 can be implemented as an algorithm on a computer processor (e.g., vital logic controller, microprocessor, FPGA, ASIC, server, etc.), a machine learning module, or other suitable system. Additionally, the MWR control logic 1500 can be achieved with software, hardware, firmware, an API, a network connection, a network transfer protocol, HTML, DHTML, JavaScript, Dojo, Ruby, Rails, other suitable applications, or a suitable combination thereof. The MWR control logic 1500 can interface electrical components to control mechanical components using logic processors.

In an embodiment, the MWR control logic 1500 can interface with a memory for storing information about railway assets, defects, and projects in a plurality of network-based non-transitory storage devices having the collection of railway information thereon. Additionally, the MWR control logic 1500 can interface the memory with a networked computer processor operably coupled to the memory and capable of executing machine-readable instructions to perform program steps. The MWR control logic 1500 implementing hardware components (e.g., computer processor) can be capable of executing machine-readable instructions to perform program steps and operably coupled to a memory for storing the information about the railway assets, defects, and projects.

The MWR control logic 1500 can leverage the ability of a computer platform to spawn multiple processes and threads by processing data simultaneously. The speed and efficiency of the MWR control logic 1500 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1500 can also be distributed amongst a plurality of networked computer processors. The MWR control logic 1500 of the present embodiment begins at step 1502.

At step 1502, in an embodiment, the control logic 1500 can receive input to determine weather at the current location corresponding to the segment of track. For example, the control logic 1500 can receive an input to capture locations of at least one of railway assets, defects, and projects. For example, the control logic 1500 can capture the locations based on information from wireless communication signals between the client device and a wireless network. In an example, the information can include location data corresponding to a current location of the client device. The location data can include latitude and longitude coordinates, GPS data, line sight markers, milepost marker information, or another sort of location data corresponding to the current location. In another example, the control logic 1500 can interface with a weather API to determine the weather information corresponding to the current location. The control logic 1500 then proceeds to step 1504.

At step 1504, in an embodiment, the control logic 1500 can determine whether the temperature information is necessary for the project. If the temperature information is necessary, the control logic 1500 then proceeds to step 1508. If the temperature information is unnecessary, the control logic 1500 then proceeds to step 1506.

At step 1506, in an embodiment, the control logic 1500 can receive input to advance the project. For example, the control logic 1500 can receive the input corresponding to advancing a process as displayed by the GUI. In an example, the control logic 1500 can display an icon indicating for the user to skip, complete, or indicate as unnecessary the temperature information for the project.

At step 1508, in an embodiment, the control logic 1500 can aggregate weather data corresponding to the location of the project. For example, the control logic 1500 can aggregate the weather data to calculate a max ambient temperature forecasted based on the project location. The max ambient temperature forecasted can be an average of the weather data. For example, the control logic 1500 can add the high temperatures for a forecast over a known project duration and divide the outcome by the known project duration to calculate the max ambient temperature forecasted. The control logic 1500 then proceeds to step 1510.

At step 1510, in an embodiment, the control logic 1500 can display a max ambient temperature forecasted. For example, the control logic 1500 can interface with a weather API. The control logic 400 can receive weather data corresponding to a location of the railway asset, defect, or project. The control logic 1500 can identify a weather forecast for the location. The weather forecast can include a series of high temperature values and a series of low temperature values. In an example, the control logic 1500 can calculate the max ambient temperature based on the weather forecast. For example, the control logic 1500 can add the high values of the weather forecast for a duration of the work to be completed and divide by the duration to determine the max ambient temperature. The control logic 1500 then proceeds to step 1512.

At step 1512, in an embodiment, the control logic 1500 can correlate the max ambient temperature forecasted to a max rail temperature during the project. For example, the control logic 1500 can compare the max ambient temperature forecasted to a temperature threshold for allowable temperatures for the project. In an example, a type of project can correspond to a requirement for low rail temperature, resulting in a low temperature for the temperature threshold. Alternatively, another type of project can correspond to an indifference of temperature, resulting in a medium-to-high temperature for the temperature threshold. The temperature threshold can correspond to the type of the project. For example, when the project is to re-weld a segment of rail on the track, the temperature threshold can be different than a project to replace ballast. The control logic 1500 then proceeds to step 1514.

At step 1514, in an embodiment, the control logic 1500 can estimate an RNT based on a change in rail length, length of unrestrained rail, a coefficient of expansion, and a TNT. For example, the RNT can be calculated based on the following equation:

$$RNT = TNT - \frac{RL}{α * L * 12}$$

Where RL is the change in rail length (in inches), α is the coefficient of expansion, L is the length of unrestrained rail.

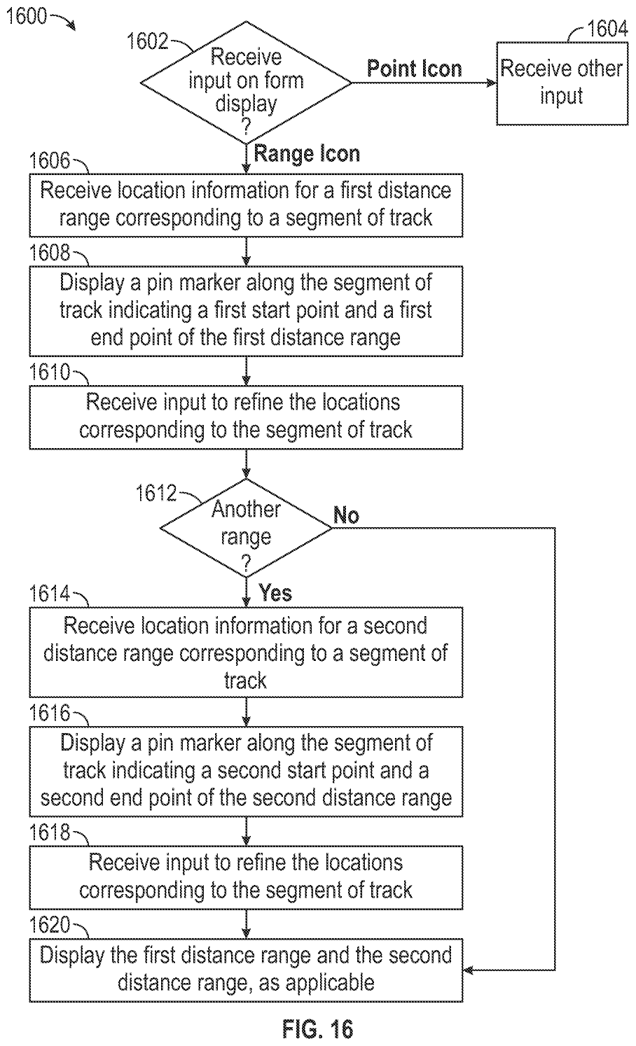

FIG. 16 illustrates a flowchart exemplifying MWR control logic 1600, in accordance with at least one embodiment of the present disclosure. The MWR control logic 1600 can be implemented as an algorithm on a computer processor (e.g., vital logic controller, microprocessor, FPGA, ASIC, server, etc.), a machine learning module, or other suitable system. Additionally, the MWR control logic 1600 can be achieved with software, hardware, firmware, an API, a network connection, a network transfer protocol, HTML, DHTML, JavaScript, Dojo, Ruby, Rails, other suitable applications, or a suitable combination thereof. The MWR control logic 1600 can interface electrical components to control mechanical components using logic processors.

In an embodiment, the MWR control logic 1600 can interface with a memory for storing information about railway assets, defects, and projects in a plurality of network-based non-transitory storage devices having the collection of railway information thereon. Additionally, the MWR control logic 1600 can interface the memory with a networked computer processor operably coupled to the memory and capable of executing machine-readable instructions to perform program steps. The MWR control logic 1600 implementing hardware components (e.g., computer processor) can be capable of executing machine-readable instructions to perform program steps and operably coupled to a memory for storing the information about the railway assets, defects, and projects.

The MWR control logic 1600 can leverage the ability of a computer platform to spawn multiple processes and threads by processing data simultaneously. The speed and efficiency of the MWR control logic 1600 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1600 can also be distributed amongst a plurality of networked computer processors. The MWR control logic 1600 of the present embodiment begins at step 1602.

At step 1602, in an embodiment, the control logic 1600 can determine whether a user interacts with a view/edit location icon. For example, the control logic 1600 can provide the user an interface to identify a location of the user. The location icon can correspond to a plurality of bits (e.g., based on a digitizer of the display 146 in FIG. 2). In an example, when the user interacts with the location icon, the bit value corresponding to the location icon can be at least one binary value. If the control logic 1600 determines the user interacts with the view/edit location icon, the control logic 1600 then proceeds to step 1606. If the control logic 1600 determines the user does not interact with the view/edit location icon, the control logic 1600 then proceeds to step 1604.

At step 1604, in an embodiment, the control logic 1600 can receive another input by the user. For example, the control logic 1600 can provide a plurality of icons. In an example, the control logic 1600 can receive inputs to at least one of the plurality of icons, where the view/edit location icon is not one of the plurality of icons.

At step 1606, in an embodiment, the control logic 1600 can receive an input to capture locations of at least one of railway assets, defects, and projects. For example, the control logic 1600 can capture the locations based on information from wireless communication signals between the client device and a wireless network. In an example, the information can include location data corresponding to a current location of the client device. The location data can include latitude and longitude coordinates, GPS data, line sight markers, milepost marker information, or another sort of location data corresponding to the current location.

In another example, the control logic 1600 can perform mathematical operations for estimating a position of the locations with respect to the client device. The mathematical operations for estimating the position can include trilateration of the position based on location data received by the control logic 1600. For example, the location data can include information corresponding to a satellite constellation over the geographic location of the user. The control logic 1600 can use the location data to estimate the position of the client device based on known reference location information. The known reference information can correspond to a locally stored reference position or calculated from a lag time of the time of flight for the location data. In an example, the control logic 1600 can coordinate the location data to a known pseudo-random code to identify a distance from the GPS constellation. In another example, the control logic 1600 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data. The control logic 1600 then proceeds to step 1608.

At step 1608, in an embodiment, the control logic 1600 can display a pin marker along a segment of track indicating a current location. For example, the control logic 1600 can display a plurality of closest track markers to the current location of the client device. In an example, the control logic 1600 can transmit the current location of the client device to an external network-based server to query the server for closest track markers to the current location. For example, the control logic 1600 can receive the closest track markers from the server and display the queries. The display of the queries can include an interactive icon-based scroll menu including the closest track markers. In an example, the closest track markers can include a line segment value and a milepost marker value. For example, the closes track markers can include a line segment value of “LS 7500” and a milepost marker of “5.6402.” The control logic 1600 then proceeds to step 1610.

At step 1610, in an embodiment, the control logic 1600 can receive input to refine the current location corresponding to the segment of track. For example, the control logic 1600 can identify the selection of the user based on the input. The input can correspond to one of the closest track markers. In this manner, the control logic 1600 can best approximate the current location of the client device with a reference frame to the closest track markers. The control logic 1600 then proceeds to step 1612.

At step 1612, in an embodiment, the control logic 1600 can determine whether another range is applicable to the project. If another range is applicable, the control logic 1600 then proceeds to step 1614. If another range is inapplicable, the control logic 1600 then proceeds to step 1620.

At step 1614, in an embodiment, the control logic 1600 can receive an input to capture locations of at least one of railway assets, defects, and projects. For example, the control logic 1600 can capture the locations based on information from wireless communication signals between the client device and a wireless network. In an example, the information can include location data corresponding to a current location of the client device. The location data can include latitude and longitude coordinates, GPS data, line sight markers, milepost marker information, or another sort of location data corresponding to the current location.

In another example, the control logic 1600 can perform mathematical operations for estimating a position of the locations with respect to the client device. The mathematical operations for estimating the position can include trilateration of the position based on location data received by the control logic 1600. For example, the location data can include information corresponding to a satellite constellation over the geographic location of the user. The control logic 1600 can use the location data to estimate the position of the client device based on known reference location information. The known reference information can correspond to a locally stored reference position or calculated from a lag time of the time of flight for the location data. In an example, the control logic 1600 can coordinate the location data to a known pseudo-random code to identify a distance from the GPS constellation. In another example, the control logic 1600 can compensate for the lag time corresponding to the time of flight of the GPS signal using clock correction capabilities. The received location data can include digital information representing the geographic position of the client device. In an example, the location data can include latitude and longitude coordinates, GPS data, milepost marker information, line segment information, or another form of location data. The control logic 1600 then proceeds to step 1616.

At step 1616, in an embodiment, the control logic 1600 can display a pin marker along a segment of track indicating a current location. For example, the control logic 1600 can display a plurality of closest track markers to the current location of the client device. In an example, the control logic 1600 can transmit the current location of the client device to an external network-based server to query the server for closest track markers to the current location. For example, the control logic 1600 can receive the closest track markers from the server and display the queries. The display of the queries can include an interactive icon-based scroll menu including the closest track markers. In an example, the closest track markers can include a line segment value and a milepost marker value. For example, the closes track markers can include a line segment value of “LS 7500” and a milepost marker of “5.6402.” The control logic 1600 then proceeds to step 1618.

At step 1618, in an embodiment, the control logic 1600 can receive input to refine the current location corresponding to the segment of track. For example, the control logic 1600 can identify the selection of the user based on the input. The input can correspond to one of the closest track markers. In this manner, the control logic 1600 can best approximate the current location of the client device with a reference frame to the closest track markers. The control logic 1600 then proceeds to step 1620.

At step 1620, in an embodiment, the control logic 1600 can display the first distance range and the second distance range, as applicable.

FIG. 17 illustrates a flowchart exemplifying MWR control logic 1700, in accordance with at least one embodiment of the present disclosure. The MWR control logic 1700 can be implemented as an algorithm on a computer processor (e.g., vital logic controller, microprocessor, FPGA, ASIC, server, etc.), a machine learning module, or other suitable system. Additionally, the MWR control logic 1700 can be achieved with software, hardware, firmware, an API, a network connection, a network transfer protocol, HTML, DHTML, JavaScript, Dojo, Ruby, Rails, other suitable applications, or a suitable combination thereof.

In an embodiment, the MWR control logic 1700 can interface with a memory for storing information about railway assets, defects, and projects in a plurality of network-based non-transitory storage devices having the collection of railway information thereon. Additionally, the MWR control logic 1700 can interface the memory with a networked computer processor operably coupled to the memory and capable of executing machine-readable instructions to perform program steps. The MWR control logic 1700 implementing hardware components (e.g., computer processor) can be capable of executing machine-readable instructions to perform program steps and operably coupled to a memory for storing the information about the railway assets, defects, and projects.

The MWR control logic 1700 can leverage the ability of a computer platform to spawn multiple processes and threads by processing data simultaneously. The speed and efficiency of the MWR control logic 1700 can be greatly improved by instantiating more than one process for monitoring a status of the railway assets, defects, and projects. However, one skilled in the art of programming will appreciate that use of a single processing thread may also be utilized and is within the scope of the present disclosure. The MWR control logic 1700 can also be distributed amongst a plurality of networked computer processors. The MWR control logic 1700 of the present embodiment begins at step 1702.

At step 1702, in an embodiment, the control logic 1700 can estimate a position of a client device (e.g., client device 175 in FIGS. 1 and 2) used by the user based on location data from a GPS receiver. For example, the control logic 1700 can receive the location data including geo-coded information corresponding to the current location of the client device. For example, the geo-coded information can include a communication packet generated such that the components of the packet include location-based information corresponding to the current location. In an example, the geo-coded information can correspond to a segment of track proximate to the client device. In another example, the control logic 1700 can receive the geo-coded information from a satellite constellation, a network-based server, a wireless communications tower, or from another form of wireless communication. In an example, the communication packet can include a location-based identifier as a header of the packet. In another example, the geo-coded information can include location identifying information such as the latitude and longitude of the current location. In an example, the control logic 1700 can receive information from the location data indicating the location of the user. The location data can include various location identifier such as geographic triangulation based on network architecture hardware. For example, the location data can correspond to communications between the client device and a wireless network. In another example, the control logic 1700 can receive location data from GPS hardware corresponding to the client device. For example, the control logic 1700 can receive the location data from an external GPS or a GPS receiver internal to the client device. The control logic 1700 then proceeds to step 1704.

At step 1704, in an embodiment, the control logic 1700 can display geographic location-based interface including a pin marker of the current location. For example, the control logic 1700 can receive location data corresponding to the current location. In an example, the control logic 1700 can receive the location data from a satellite constellation. The location data can identify the current location and proximate locations to the current location. For example, the location data can identify the segment of track and track marker identifiers along the segment of track. The control logic 1700 can transmit the refined location. The control logic 1700 then proceeds to step 1706.

At step 1706, in an embodiment, the control logic 1700 can determine whether a position of the client device is accurate. For example, the control logic 1700 can provide the user an interface to identify whether the user requests updating the position of the client device with regards to a geographic location-based interface. The geographic location-based interface can correspond to a plurality of bits (e.g., based on a digitizer of the display 146). In an example, when the user interacts with the geographic location-based interface to enter a new position of the client device on the geographic location-based interface, the bit value corresponding to the location icon can be at least one binary value. If the control logic 1700 determines the user interacts with the geographic location-based interface based on a corresponding binary value, the control logic 1700 then proceeds to step 912. If the control logic 1700 determines the user does not interact with the geographic location-based interface based on a corresponding binary value, the control logic 1700 then proceeds to step 1708.

At step 1708, in an embodiment, the control logic 1700 can receive an input to select a refined position of the client device on the interface. For example, the control logic 1700 can receive the input indicating the user is to drag the pin marker to the new location on the geographic location-based interface. The control logic 1700 then proceeds to step 1710.

At step 1710, in an embodiment, the control logic 1700 can identify the refined position of the client device based on location data from a GPS receiver and the pin marker identifying the refined position. In an example, the control logic 1700 can receive input from the user to modify the current location. For example, the control logic 1700 can identify the refined position based on known location parameters from the GPS receiver. In an example, the control logic 1700 can reference the position of the pin marker on the geographic location-based interface with physical locations proximate to the position of the client device. For example, the control logic 1700 can interface with the GPS receiver such that the GPS receiver provides location data of the physical locations proximate to the client device. The control logic 1700 can transmit the refined position of the client device. In this manner, the control logic 1700 can receive the input from the user in the form of the user interacting with the location-based interface by touching and sliding the pin marker to a refined location. The control logic 1700 can identify the refined location based on the location data. The control logic 1700 then proceeds to step 1712.

At step 1712, in an embodiment, the control logic 1700 can receive confirmation for the position of the client device. For example, the control logic 1700 can receive an input indicating the user confirms the new position. The confirmation can correspond to the control logic 1700 receiving the input that can correspond to a plurality of bits (e.g., based on a digitizer of the display 146). In an example, when the user interacts with the control logic 1700 to confirm the new position, the bit value corresponding to the location icon can be at least one binary value. The control logic 1700 then proceeds to step 1714.

At step 1714, in an embodiment, the control logic 1700 can display the new position on the geographic location-based interface. For example, the control logic 1700 can provide a digital representation of the geographic location-based interface on the client device. In an example, the control logic 1700 can display the new position in reference to the current location. The control logic 1700 then proceeds to step 1716.

At step 1716, in an embodiment, the control logic 1700 can identify location data corresponding to the new position of the client device. For example, the control logic 1700 can reference the new position to proximate locations to the client device. In this manner, the control logic 1700 can provide corresponding location data to another location input parameter for updating a status for at least one of railway assets, defects, and projects. For example, the control logic 1700 can store the location data in local memory such that the control logic 1700 can reference the location data when necessary. In an example, the control logic 1700 can reference the location data when completing another location input for the update. The control logic 1700 then proceeds to step 1718.

At step 1718, in an embodiment, the control logic 1700 can auto-populate a location field using the location data corresponding to the position of the client device. For example, the control logic 1700 can reference the location data from local memory to populate another location input. In an example, the control logic 1700 can populate the location data in a location field for a new update when the client device is at a same location as identified using the location data.

The present disclosure achieves at least the following advantages:
1. Geolocating a client device to cross-reference proximate locations of at least one of the railway assets, defects, and projects for managing and reporting work along a segment of track.
2. Providing refined locations for accurate management of the railway assets, defects, and projects along the segment of track.
3. Providing real-time communications across an entire organization while minimizing communication bottlenecks.
4. Providing a GUI for simplifying and managing communications for an MWR system.
5. Optimizing communications by identifying relevant information based on technical groups corresponding to the railway assets, defects, and projects.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A method for mobile reporting of railroad operations, including:
determining a location, at a mobile device comprising a global positioning system (GPS) receiver, a microprocessor, a display, and a wireless communication transceiver, by displaying a course location received by the GPS receiver from a plurality of GPS satellites and receiving a location refinement from a user;
refining the location using a user interface configured to display a map and a location icon on the mobile device;
reporting temporary and permanent remedial actions, root causes, measurements, methods of repair, and photos and/or notes as applicable to various defect types;
using a hub design that shows user work around the location;
embedding training components relevant to a current task;
geo-coding track safety information; and
automatically reporting track inspection work orders.

2. The method of claim 1, further comprising generating automated estimated time of arrival with turn-by-turn directions, asset specific or GPS pinpoint location accuracy, close out codes, and photo/notes.

3. The method of claim 1, further comprising automatically reporting all track inspection work orders.

4. The method of claim 1, further comprising generating a max ambient temperature forecasted based on a project location.

5. The method of claim 1, further comprising estimating a rail neutral temperature (RNT) based on a change in rail length, length of unrestrained rail, a coefficient of expansion, and a track neutral temperature (TNT).

6. The method of claim 1, further comprising locally storing a project file in a structured format and wirelessly transmitting the project file to a gang client device.

7. The method of claim 1, further comprising displaying a first distance range and a second distance range along the segment of track.

8. The method of claim 7, further comprising measuring the first distance range and the second distance range based on a railway centerline from positive train control (PTC) data.

9. The method of claim 1, further comprising generating a project corresponding to a rail, a ballast, or at least one railway tie.

10. The method of claim 9, further comprising generating the project corresponding to the rail to compensate for railway asset repair including digitally assigning user information to the railway asset repair.

11. A system for mobile reporting of railroad operations, including:
a mobile device comprising:
a global positioning system (GPS) receiver;
a microprocessor, wherein the microprocessor is configured to receive instructions corresponding to the operations of the mobile device;
a wireless communication transceiver; and
a display;
a memory for storing information about railway assets, defects, and projects in a plurality of network-based non-transitory storage devices having the collection of railway information thereon; and
a networked computer processor operably coupled to the memory and capable of executing machine-readable instructions to perform program steps, the program steps comprising:
determining a location, at a mobile device comprising a GPS receiver, a microprocessor, a display, and a wireless communication transceiver, by displaying a course location received by the GPS receiver from a plurality of GPS satellites and receiving a location refinement from a user;
refining the location using a user interface configured to display a map and a location icon on the mobile device;
reporting temporary and permanent remedial actions, root causes, measurements, methods of repair, and photos and/or notes as applicable to various defect types;
using a hub design that shows user work around the location;
embedding training components relevant to a current task;
geo-coding track safety information; and
automatically reporting track inspection work orders.

12. The system of claim 11, wherein the program steps further cause the processor to perform the step of generating automated estimated time of arrival with turn-by-turn directions, asset specific or GPS pinpoint location accuracy, close out codes, and photo/notes.

13. The system of claim 11, wherein the program steps further cause the processor to perform the step of automatically reporting all track inspection work orders.

14. The system of claim 11, wherein the program steps further cause the processor to perform the step of generating a max ambient temperature forecasted based on a project location.

15. The system of claim 11, wherein the program steps further cause the processor to perform the step of estimating a rail neutral temperature (RNT) based on a change in rail length, length of unrestrained rail, a coefficient of expansion, and a track neutral temperature (TNT).

16. The system of claim 11, wherein the program steps further cause the processor to perform the step of locally storing a project file in a structured format and wirelessly transmitting the project file to a gang client device.

17. The system of claim 11, wherein the program steps further cause the processor to perform the step of displaying a first distance range and a second distance range along the segment of track.

18. The system of claim 17, wherein the program steps further cause the processor to perform the step of measuring the first distance range and the second distance range based on a railway centerline from positive train control (PTC) data.

19. The system of claim 11, wherein the program steps further cause the processor to perform the step of generating a project corresponding to a rail, a ballast, or at least one railway tie.

20. The system of claim 19, wherein the program steps further cause the processor to perform the step of generating the project corresponding to the rail to compensate for railway asset repair including digitally assigning user information to the railway asset repair.

21. A computer-implemented method for mobile reporting of railroad operations, including:
determining a location, at a mobile device comprising a global positioning system (GPS) receiver, a microprocessor, a display, and a wireless communication transceiver, by displaying a course location received by the GPS receiver from a plurality of GPS satellites and receiving a location refinement from a user;
refining the location using a user interface configured to display a map and a location icon on the mobile device;
reporting temporary and permanent remedial actions, root causes, measurements, methods of repair, and photos and/or notes as applicable to various defect types;
using a hub design that shows user work around the location;
embedding training components relevant to a current task;
geo-coding track safety information; and
automatically reporting track inspection work orders.

22. The computer-implemented of claim 21, further comprising generating automated estimated time of arrival with turn-by-turn directions, asset specific or GPS pinpoint location accuracy, close out codes, and photo/notes.

23. The computer-implemented of claim 21, further comprising automatically reporting all track inspection work orders.

24. The computer-implemented of claim 21, further comprising generating a max ambient temperature forecasted based on a project location.

25. The computer-implemented of claim 21, further comprising estimating a rail neutral temperature (RNT) based on a change in rail length, length of unrestrained rail, a coefficient of expansion, and a track neutral temperature (TNT).

26. The computer-implemented of claim 21, further comprising locally storing a project file in a structured format and wirelessly transmitting the project file to a gang client device.

27. The computer-implemented of claim 21, further comprising displaying a first distance range and a second distance range along the segment of track.

28. The computer-implemented of claim 27, further comprising measuring the first distance range and the second distance range based on a railway centerline from positive train control (PTC) data.

29. The computer-implemented of claim 21, further comprising generating a project corresponding to a rail, a ballast, or at least one railway tie.

30. The computer-implemented of claim 29, further comprising generating the project corresponding to the rail to compensate for railway asset repair including digitally assigning user information to the railway asset repair.
